(19) United States
(12) Patent Application Publication
(10) Pub. No.: US 2018/0164211 A1
(43) Pub. Date: Jun. 14, 2018

(54) Gas Detection Device and Gas Detection Method

(71) Applicant: Konica Minolta, Inc., Tokyo (JP)

(72) Inventors: Masashi KAGEYAMA, Hachioji-shi, Tokyo (JP); Hikaru NAGASAWA, Hanno-shi, Saitama (JP); Ryouta ISHIKAWA, Hino-shi, Tokyo (JP); Kyuichiro IMADE, Mitaka-shi, Tokyo (JP)

(73) Assignee: Konica Minolta, Inc., Tokyo (JP)

(21) Appl. No.: 15/742,261

(22) PCT Filed: Jul. 11, 2016
(86) PCT No.: PCT/JP2016/070481

§ 371 Date: Jan. 5, 2018

(30) Foreign Application Priority Data
Jul. 17, 2015 (JP) 2015-143045

(51) Int. Cl. G01N 21/39; G01N 21/3504; G01N 21/359

(52) U.S. Cl. CPC G01N 21/39; G01N 2201/06113; G01N 21/359; G01N 21/3504

(57) ABSTRACT

In a gas detection device and a gas detection method of the present invention, frequency-modulated detection light is irradiated while being scanned, a light reception output signal obtained by receiving reflected light of the detection light is subjected to phase-sensitive detection, a resulting detection output signal is sampled, and detection target gas GA is detected on the basis of a sampling result. A modulation frequency of the detection light is controlled on the basis of a scanning speed.

### TECHNICAL FIELD

The present invention relates to a gas detection device and a gas detection method for detecting detection target gas.

### BACKGROUND ART

For example, in the case of leakage of gas such as flammable gas, toxic gas and organic solvent steam from a pipe, a tank or the like, such a situation needs to be promptly dealt with. Thus, devices for detecting gas have been and are being studied and developed. A technology utilizing an absorption line of a light absorption spectrum of gas is known as one of technologies for detecting gas. This technology utilizes a property that the attenuation of light having a frequency (wavelength) of an absorption line is proportional to a gas concentration. In principle, laser light having the frequency of the absorption line is irradiated to gas, the attenuation of the laser light passed through the gas is measured and the gas concentration is measured by multiplying this measurement result by a conversion coefficient set in advance. Measurement methods based on this principle typically include a two-wavelength differential method and a frequency modulation method (2f detection method) (see, for example, patent literature 1).

In this frequency modulation method (2f detection method), laser light having a frequency fc of an absorption line is frequency-modulated at a modulation frequency fm, and the laser light frequency-modulated at the modulation frequency fm using this frequency fc of the absorption line as a center frequency fc is irradiated to gas and received by a light reception unit after passing through the gas. Here, a light absorption spectrum of the gas has a line-symmetrical profile with respect to the frequency fc of the absorption line such as a quadratic function profile in a range near the frequency of the absorption line. Thus, an output signal of the light reception unit includes not only a component of the modulation frequency fm, but also a component of 2fm (second harmonic). This component of the second harmonic 2fm is subjected to phase-sensitive detection, and a gas concentration is obtained on the basis of this component of the second harmonic 2fm subjected to phase-sensitive detection. Note that the influence of a received light intensity variation (noise) due to factors excluding the gas can be reduced by subjecting the component of the modulation frequency fm also to phase-sensitive detection simultaneously with the phase-sensitive detection of the second harmonic 2fm and normalizing the amount of the received light (by obtaining a ratio of the component of the second harmonic 2fm to the component of the modulation frequency fm).

A gas concentration measurement device disclosed, for example, in patent literature 2 is known as one of devices using such a frequency modulation method. The gas concentration measurement device disclosed in this patent literature 2 includes a sensing light radiation unit for radiating sensing light, a light reception unit for receiving reflected light reflected from an object when the sensing light is irradiated to the object, a column density measurement unit for measuring a column density of the gas to be detected from the reflected light received by the light reception unit, an optical path length measurement unit for measuring an optical path length of the sensing light from the sensing light radiation unit to the object and a concentration calculation unit for calculating a concentration of the gas to be detected on the basis of the column density and the optical path length. Then, the concentration calculation unit calculates an average concentration of the gas to be detected along an optical path of the sensing light by dividing the column density by the optical path length.

In the case of measurement by scanning the laser light, if a scanning speed is increased, a measurement interval along a scanning direction becomes wider than before the scanning speed is increased. Thus, a density of detection points (measurement points) becomes coarse. Thus, if a sampling period (sampling interval, sampling frequency) along the scanning direction is shortened (shorter interval, higher frequency) according to an increase in the scanning direction, the coarsening (sparseness) of the density of the measurement points is reduced. For example, in the case where the scanning speed is doubled, the density of the measurement points is equal before and after the increase of the scanning speed if the sampling period along the scanning direction is halved. However, in this case, the number of light reception signal samples one measurement point decreases, wherefore detection accuracy is degraded (reduced).

On the other hand, it is aimed in the above patent literature 2 to obtain the gas concentration, and a situation associated with the aforementioned increase of the scanning speed is neither described nor indicated in the above patent literature 2.

### CITATION LIST

### Patent Literature

Patent literature 1: Japanese Unexamined Patent Publication No. H07-151681

Patent literature 2: Japanese Unexamined Patent Publication No. 2014-55858

### SUMMARY OF INVENTION

The present invention was developed in view of the above situation and aims to provide a gas detection device and a gas detection method capable of reducing the degradation of detection accuracy even if a scanning speed is increased.

In a gas detection device and a gas detection method according to the present invention, frequency-modulated detection light is irradiated while being scanned, a light reception output signal obtained by receiving reflected light of the detection light is subjected to phase-sensitive detection, a resulting detection output signal is sampled, and detection target gas GA is detected on the basis of a sampling result. A modulation frequency of the detection light is controlled on the basis of a scanning speed. Thus, the gas detection device and the gas detection method according to the present invention can reduce the degradation of detection accuracy even if the scanning speed is increased.

The above and other objects, features and advantages of the present invention will become apparent from the following detailed description and the accompanying drawings.

### BRIEF DESCRIPTION OF DRAWINGS

FIG. 1 is a block diagram showing the configuration of a gas detection device in an embodiment,

FIG. 2 are diagrams showing the configuration of a first phase-sensitive detection unit in the gas detection device,

FIG. 3 are diagrams showing the configuration of a second phase-sensitive detection unit in the gas detection device,

FIG. 4 is a graph showing a frequency modulation method (2f detection method),

FIG. 5 are diagrams showing a relationship between a scanning speed and a measurement point density and a relationship between a distance and the measurement point density,

FIG. 6 is a flow chart showing the operation of the detection device,

FIG. 7 is a graph showing a relationship of the scanning speed and a modulation frequency and a relationship between the distance and the modulation frequency,

FIG. 8 is a chart showing a detection synchronous timing of a synchronization signal in response to an output signal in the first and second phase-sensitive detection units, and

FIG. 9 is a chart showing the adjustment of a detection synchronous timing of a gas detection device in a modification.

### DESCRIPTION OF EMBODIMENT

Hereinafter, one embodiment according to the present invention is described with reference to the drawings. Note that components denoted by the same reference signs have the same configurations in each figure and the description thereof is omitted as appropriate.

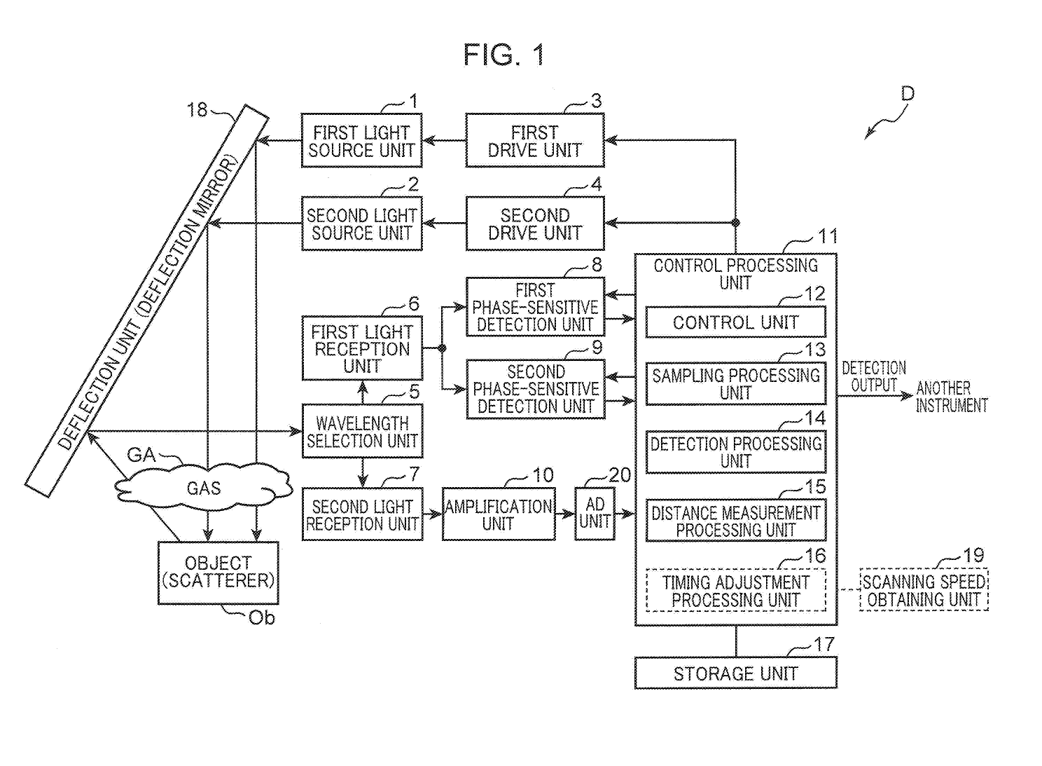

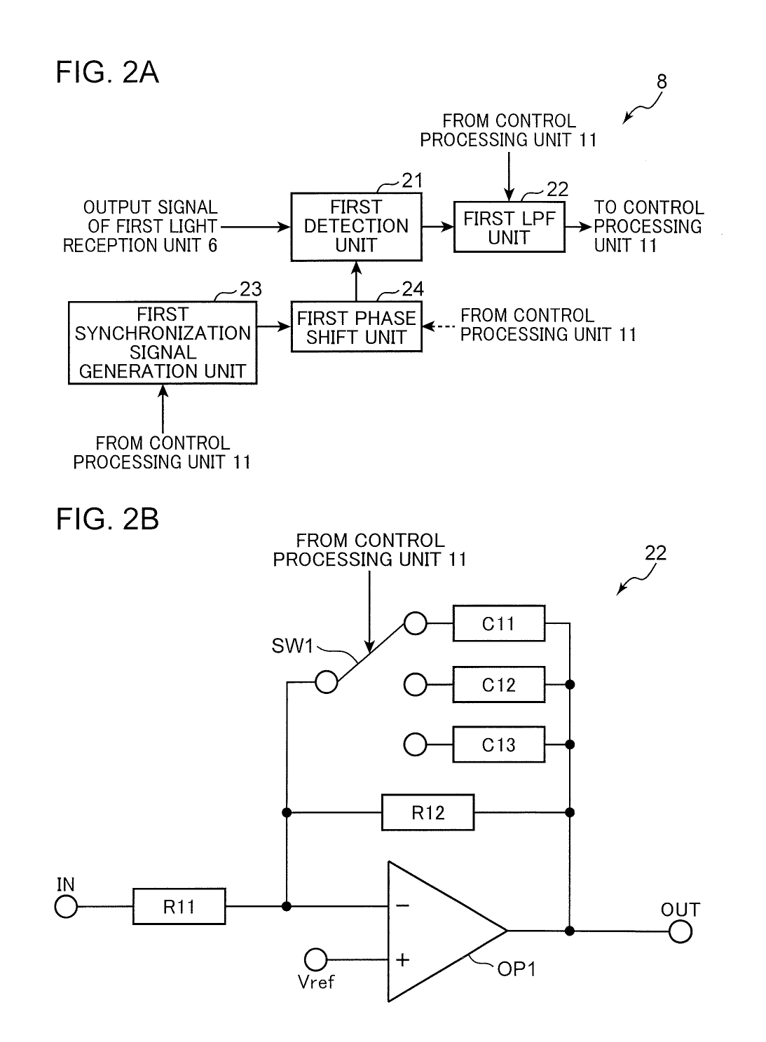

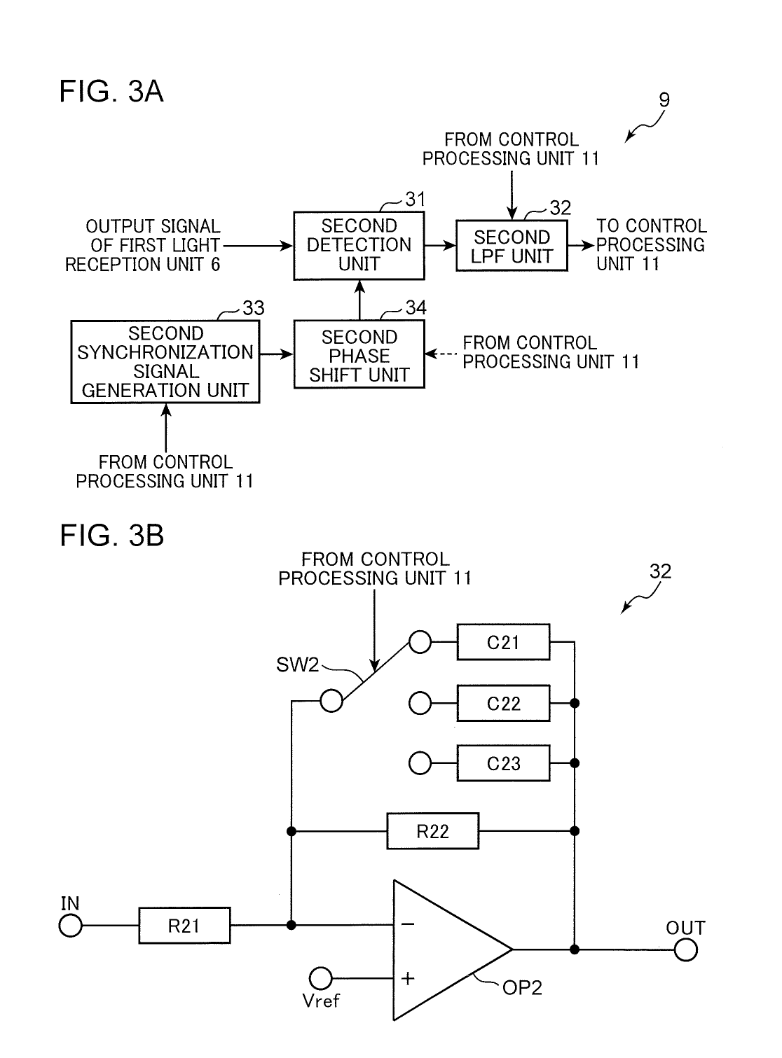

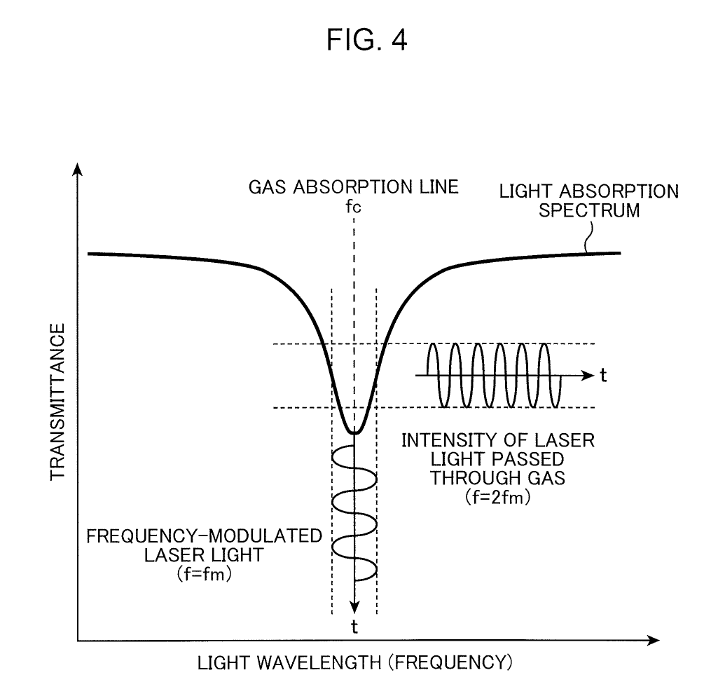

FIG. 1 is a block diagram showing the configuration of a gas detection device in the embodiment. FIG. 2 are diagrams showing the configuration of a first phase-sensitive detection unit in the gas detection device of the embodiment. FIG. 2A is a block diagram showing the entire configuration of the first phase-sensitive detection unit, and FIG. 2B is a circuit diagram showing the configuration of a first LPF unit in the first phase-sensitive detection unit. FIG. 3 are block diagrams showing the configuration of a second phase-sensitive detection unit in the gas detection device of the embodiment. FIG. 3A is a block diagram showing the entire configuration of the second phase-sensitive detection unit, and FIG. 3B is a circuit diagram showing the configuration of a second LPF unit in the second phase-sensitive detection unit. FIG. 4 is a graph showing a frequency modulation method (2f detection method).

The gas detection device in the embodiment is a device for detecting detection target gas GA by a so-called frequency modulation method (2f detection method) and, for example, irradiates detection light Lc frequency-modulated at a predetermined modulation frequency fm using a predetermined frequency fc as a center frequency fc, receives reflected light (return light) Lcr of this detection light Lc by an object and detects the detection target gas GA on the basis of this received reflected light Lcr.

More specifically, such a gas detection device D includes a first light source unit 1, a second light source unit 2, a first drive unit 3, a second drive unit 4, a wavelength selection unit 5, a first light reception unit 6, a second light reception unit 7, a first phase-sensitive detection unit 8, a second phase-sensitive detection unit 9, an amplification unit 10, a control processing unit 11, a storage unit 17, a deflection unit 18, an analog-digital conversion unit (AD unit) 20, for example, as shown in FIG. 1.

The first light source unit 1 is a device connected to the first drive unit 3 and configured to irradiate the detection light Lc frequency-modulated at the predetermined modulation frequency fm using the predetermined first frequency fc as the center frequency fc in the form of continuous light (CW light) for the detection of the detection target gas GA and includes, for example, a wavelength variable semiconductor laser or the like that can emit laser light while changing a wavelength. The modulation frequency fm is appropriately set, e.g. at 10 kHz, 50 kHz or 100 kHz. The first frequency (center frequency) fc is a frequency of a predetermined absorption line in a light absorption spectrum of the detection target gas GA and appropriately set according to the type of the detection target gas GA. For example if the detection target gas GA is methane (CH₄), the first frequency (center frequency) fc is set at a frequency of a predetermined absorption line in a light absorption spectrum of methane. Although there are a plurality of absorption lines in the light absorption spectrum of methane, an absorption line having a wavelength of 1653 nm, which is an R(3) line, or an absorption line having a wavelength of 1651 nm, which is a R(4) line, at which methane is most strongly absorbed, is employed in this embodiment and the first frequency (center frequency) fc is a frequency equivalent to the wavelength of 1653 nm or the wavelength of 1651 nm.

Note that the detection target gas GA is not limited to methane and may be various types of gas as shown in Table 1. Gas types and wavelengths (m) of absorption lines thereof are shown as examples of the detection target gas GA in Table 1.

TABLE 1

| Gas Type | Wavelength (μm) |
|---|---|
| H₂O | 1.365 |
| CO | 1.567 |
| CO₂ | 1.573 |
| | 2.004 |
| NH₃ | 1.544 |
| C₂H₂ | 1.53 |
| H₂S | 1.578 |
| N₂O | 1.954 |
| NO | 1.795 |
| HCl | 1.742 |

The first drive unit 3 is a device connected to the control processing unit 11 and configured to drive the first light source unit 1 to irradiate the detection light Lc frequency-modulated at the predetermined modulation frequency fm using the predetermined first frequency as the center frequency fc in the form of continuous light (CW light) in accordance with a control of the control processing unit 11. For example, the first drive unit 3 causes the first light source unit 1 to irradiate the detection light Lc by supplying a drive current modulated for the frequency modulation of the detection light LC at the modulation frequency fm to the variable wavelength semiconductor laser in accordance with the control of the control processing unit 11.

The second light source unit 2 is a device connected to the second drive unit 4 and configured to irradiate predetermined distance measurement light Ld having a second frequency fx (≠fc) different from the first frequency fc of the detection light Lc in the form of pulsed light for distance measurement and includes, for example, a semiconductor laser or the like. The second frequency fd is appropriately set to be different from the first frequency fc of the detection light Lc. Since the first frequency fc of the detection light Lc is the frequency of the absorption line in the detection target gas GA in this embodiment, the second frequency fd of the distance measurement light Ld is a frequency other than the frequency fc of the absorption line in the detection target gas GA. As an example, since the first frequency fc of the detection light Lc is the frequency equivalent to the wavelength of 1651 nm or the wavelength of 1653 nm in this embodiment, the second frequency fd is a frequency equivalent to any one of wavelengths (e.g. 800 nm, 870 nm, 905 nm, 1000 nm) in a wavelength range of 800 nm to 1000 nm. Note that the second frequency fd of the distance measurement light Ld is preferably a frequency other than frequencies of absorption lines in other types of gas different from the detection target gas GA supposed to be present in a space where the detection target gas GA is present.

The second drive unit 4 is a device connected to the control processing unit 11 and configured to drive the second light source unit 2 to irradiate the predetermined distance measurement light Ld having the second frequency fx (≠fc) in the form of pulsed light in accordance with the control of the control processing unit 11. For example, the second drive unit 4 causes the second light source unit 2 to irradiate the distance measurement light Ld by supplying a pulsed drive current to the semiconductor laser in accordance with the control of the control processing unit 11.

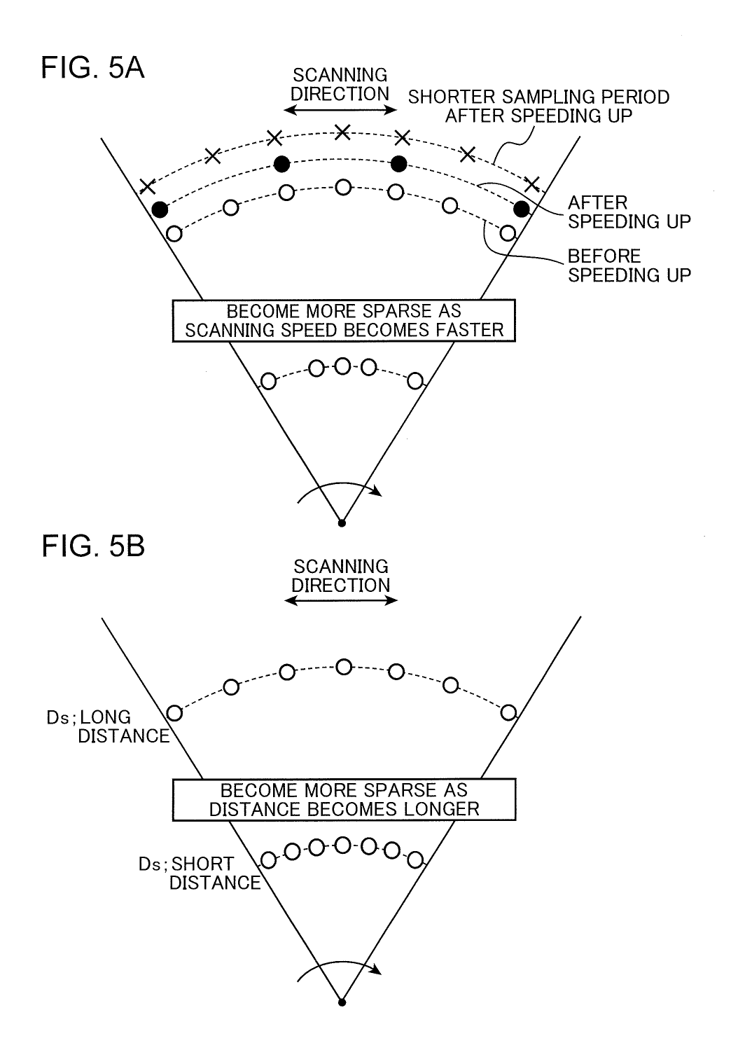

The deflection unit 18 is a device on which the detection light Lc emitted from the first light source unit 1 is incident and which irradiates the detection light Lc successively in a plurality of mutually different directions for detection at a plurality of detection points while scanning the detection light Lc along a predetermined scanning direction. In this embodiment, the distance measurement light Ld emitted from the second light source unit 2 is also incident on the deflection unit 18 so as to be able to measure a distance Ds to an object Ob, to which the detection light Lc is irradiated and which generates the reflected light Lcr based on the detection light Lc, and the deflection unit 18 irradiates the distance measurement light Ld in the same directions as the detection light Lc while scanning the distance measurement light Ld in a predetermined scanning direction. In this embodiment, first reflected light (return light) generated on the basis of the detection light Lc by the object Ob irradiated with the detection light Lc and second reflected light (second return light) Ldr generated on the basis of the distance measurement light Ld by the object Ob irradiated with the distance measurement light Ld are also incident on the deflection unit 18, and the deflection unit 18 irradiates these first reflected light Lcr and second reflected light Ldr to the wavelength selection unit 5. Such a deflection unit 18 includes, for example, a deflection mirror (reflection mirror) in the form of a flat plate and an actuator such as a motor for rotating the deflection mirror about a predetermined axis, and successively changes a first incident angle of the detection light Lc emitted from the first light source unit 1 and a second incident angle of the distance measurement light Ld emitted from the second light source unit 2 by rotating the deflection mirror about the predetermined axis by the actuator. In this way, the deflection unit 18 radially irradiates the detection light Lc with an irradiation receiving point (position of an axis of rotation AX of the deflection mirror in this example) of the detection light Lc as a center, thereby irradiating the detection light Lc while scanning the detection light Lc along the predetermined scanning direction, which is a circumferential direction (circumferential direction about the predetermined axis in this example) intersecting a radiation direction (see FIG. 5 to be described later). Note that although the deflection mirror is perpendicular to the plane of FIG. 1 in the example shown in FIG. 1, the deflection mirror may be inclined (may be inclined with respect to a normal direction to the plane of FIG. 1).

In this embodiment, a first optical axis of the detection light Lc and a second optical axis of the distance measurement light Ld are parallel to each other as shown in FIG. 1. Specifically, the first and second light source units 1, 2 are so arranged with respect to the deflection unit 18 that the first optical axis of the detection light Lc and the second optical axis of the distance measurement light Ld are parallel to each other (the first incident angle of the detection light Lc on the deflection mirror and the second incident angle of the distance measurement light Ld on the deflection mirror are equal to each other). The first optical axis of the detection light Lc and the second optical axis of the distance measurement light Ld are preferably proximately parallel to each other, more preferably most proximately parallel to each other without overlapping each other to more suitably measure the distance Ds to the object Ob that generates the reflected light Lcr.

The wavelength selection unit 5 is a device on which the first reflected light Lcr of the detection light Lc and the second reflected light Ldr of the distance measurement light Ld are incident and which substantially separately emits the first reflected light Lcr of the detection light Lc and the second reflected light Ldr of the distance measurement light Ld. The first reflected light Lcr of the detection light Lc emitted from the wavelength selection unit 5 is incident on the first light reception unit 6, and the second reflected light Ldr of the distance measurement light Ld emitted from the wavelength selection unit 5 is incident on the second light reception unit 7. Such a wavelength selection unit 5 includes a dichroic mirror for reflecting the first reflected light Lcr of the detection light Lc emitted from the wavelength selection unit 5 toward the first light reception unit 6 and transmitting the second reflected light Ldr of the distance measurement light Ld emitted from the wavelength selection unit 5 so that the second reflected light Ldr is received by the second light reception unit 7, and the like. Further, the wavelength selection unit 5 includes, for example, a half mirror for branching incident light into two, a first band-pass filter on which one part branched (reflected) by the half mirror is incident and which transmits a wavelength band including the first reflected light Lcr of the detection light Lc and a second band-pass filter on which one part branched (transmitted) by the half mirror is incident and which transmits a wavelength band including the second reflected light Ldr of the distance measurement light Ld, the light emitted from the first band-pass filter (mainly including the first reflected light Lcr of the detection light Lc) is incident on the first light reception unit 6, and the light emitted from the second band-pass filter (mainly including the second reflected light Ldr of the distance measurement light Ld) is incident on the second light reception unit 7.

The first light reception unit 6 is a device connected to each of the first and second phase-sensitive detection units 8, 9 and configured to receive and photoelectrically convert the first reflected light Lcr of the detection light Lc emitted from the wavelength selection unit 5, thereby outputting an electrical signal (first output signal) SG1 of a level corresponding to the light intensity of the first reflected light Lcr to each of the first and second phase-sensitive detection units 8, 9.

The second light reception unit 7 is a device connected to the amplification unit 10 and configured to receive and photoelectrically convert the second reflected light Ldr of the distance measurement light Ld emitted from the wavelength selection unit 5, thereby outputting an electrical signal (second output signal) SG2 of a level corresponding to the light intensity of the second reflected light Ldr to the amplification unit 10.

In this embodiment, a first light receiving sensitivity wavelength band of the first light reception unit 6 and a second light receiving sensitivity wavelength band of the second light reception unit 7 are different from each other by a predetermined sensitivity threshold value (e.g. 40%, 50% and 60% to maximum sensitivity). The first light receiving sensitivity wavelength band of the first light reception unit 6 and the second light receiving sensitivity wavelength band of the second light reception unit 7 may overlap each other by less than a predetermined sensitivity threshold value, but preferably such an overlapping part is absent and the two light receiving sensitivity wavelength bands are different from each other. More specifically, since the wavelength of the detection light Lc is 1651 nm or 1653 nm in this embodiment, the first light reception unit 6 includes an InGaAs (indium gallium arsenide) light receiving element (InGaAs photodiode) having superior light receiving sensitivity to a 1600 nm wavelength band. Since the wavelength of the distance measurement light Ld is any one of wavelengths in the wavelength range of 800 nm to 1000 nm, the second light reception unit 7 includes a Si (silicon) light receiving element (Si photodiode) having superior light receiving sensitivity to a 800 nm-1000 nm wavelength band. Because of high sensitivity, the second light reception unit 7 more preferably includes a Si avalanche photodiode.

The first phase-sensitive detection unit 8 is a device connected to the control processing unit 11 and configured to perform a phase-sensitive detection of the first output signal SG1 of the first light reception unit 6 on the basis of the modulation frequency fm at which the detection light Lc is frequency-modulated. The first phase-sensitive detection unit 8 outputs a phase-sensitive detection result (first phase-sensitive detection result) to the control processing unit 11. Such a first phase-sensitive detection unit 8 includes, for example, a first detection unit 21, a first low-pass filter unit (first LPF unit) 22, a first synchronization signal generation unit 23 and a first phase shift unit 24 as shown in FIG. 2A.

The first synchronization signal generation unit 23 is a circuit connected to the control processing unit 11 and the first phase shift unit 24 and configured to generate a first synchronization signal SS1 in the form of a rectangular pulse having a duty ratio of 50% at the modulation frequency fm in accordance with the control of the control processing unit 11 and includes, for example, an oscillator and the like. The first synchronization signal generation unit 23 outputs this generated first synchronization signal SS1 to the first phase shift unit 24.

The first phase shift unit 24 is a circuit connected to the first detection unit 21 and configured to change (advance or delay) the phase of the first synchronization signal SS1 of the first synchronization signal generation unit 23 at a predetermined timing set in advance so that the first synchronization signal SS1 is synchronized with a component of the modulation frequency fm and includes, for example, a phase shifter and the like. The first phase shift unit 24 outputs the first synchronization signal SS1 changed to a predetermined phase to the first detection unit 21.

The first detection unit 21 is a circuit connected to the first LPF unit 22 and configured to synchronously detect an output signal of the first light reception unit 6 input from the first light reception unit 6 on the basis of the first synchronization signal SS1 input from the first phase shift unit 24 and includes, for example, a multiplier and the like or a switching element and the like. A frequency component equal to the first synchronization signal SS1, i.e. the component of the modulation frequency fm is extracted from the output signal of the first light reception unit 6 by this synchronous detection. The first detection unit 21 outputs a synchronous detection result to the first LPF unit 22.

The first LPF unit 22 is a circuit connected to the control processing unit 11 and configured to filter the synchronous detection result input from the first detection unit 21 and cause only components equal to or below a predetermined cut-off frequency fcut to pass. The first LPF unit 22 outputs this filtering result to the control processing unit 11 as a first phase-sensitive detection result of the first phase-sensitive detection unit 8. In this embodiment, the first LPF unit 22 is configured to be able to change a low-pass band thereof, i.e. the cut-off frequency fcut, in accordance with the control of the control processing unit 11.

Such a first LPF unit 22 is, for example, a so-called integration circuit with 11^{th} and 12^{th} resistance elements R11, R12, three 11^{th} to 13^{th} capacitors C11, C12 and C13 having mutually different capacitances, a first operational amplifier OP1 and a first selection switch SW1 with one input and three outputs as shown in FIG. 2B.

An output terminal of the first detection unit 21 is connected to an inverting input terminal (−) of the first operational amplifier OP1 via the 11^{th} resistance element R11. A predetermined reference voltage (base voltage) Vref set in advance is input to a non-inverting input terminal (+) of the first operational amplifier OP1. The 12^{th} resistance element R12 is connected between the inverting input terminal (−) of the first operational amplifier OP1 and an output terminal of the first operational amplifier OP1. An input terminal of the first selection switch SW1 is connected to the inverting input terminal (−) of the first operational amplifier OP1. An 11^{th} output terminal of the first selection switch SW1 is connected to the output terminal of the first operational amplifier OP1 via the 11^{th} capacitor C11. A 12^{th} output terminal of the first selection switch SW1 is connected to the output terminal of the first operational amplifier OP1 via the 12^{th} capacitor C12. A 13^{th} output terminal of the first selection switch SW1 is connected to the output terminal of the first operational amplifier OP1 via the 13^{th} capacitor C13. Connected state between the input terminal of the first selection switch SW1 and the 11^{th} to 13^{th} output terminals are set according to a control signal of the control processing unit 11. Specifically, the first selection switch SW1 connects the input terminal to any one of the 11^{th} to 13^{th} output terminals according to the control signal of the control processing unit 11. An output (output terminal) of the first operational amplifier OP1 is an output (output terminal) of the first phase-sensitive detection unit 8.

Since the cut-off frequency fcut in the first LPF unit 22 having such a circuit configuration is specified by a resistance value of the 12^{th} resistance element R12 and the capacitance of the capacitor C connected between the inverting input terminal (−) and the output terminal in the first operational amplifier OP1, the first LPF unit 22 can change the cut-off frequency fcut, i.e. the low-pass band, by switching the capacitor C to be connected between the inverting input terminal (−) and the output terminal in the first operational amplifier OP1. The modulation frequency fm is changed as described above, but the resistance value of the 12^{th} resistance element R12 and the capacitance of each of the 11^{th} to 13^{th} capacitors C11 to C13 are appropriately set according to a change range of the modulation frequency fm.

The second phase-sensitive detection unit 9 is a device connected to the control processing unit 11 and configured to perform a phase-sensitive detection of the first output signal SG1 of the first light reception unit 6 on the basis of a frequency (second harmonic) 2fm, which is twice the modulation frequency fm at which the detection light Lc is frequency-modulated, in accordance with the control of the control processing unit 11. The second phase-sensitive detection unit 9 outputs a phase-sensitive detection result (second phase-sensitive detection result) to the control processing unit 11. Such a second phase-sensitive detection unit 9 is basically similar to the first phase-sensitive detection unit 8 and includes, for example, a second detection unit 31, a second low-pass filter unit (second LPF unit) 32, a second synchronization signal generation unit 33 and a second phase shift unit 34 as shown in FIG. 3A.

The second synchronization signal generation unit 33 is a circuit connected to the control processing unit 11 and the second phase shift unit 34 and configured to generate a second synchronization signal SS2 in the form of a rectangular pulse having a duty ratio of 50% at the frequency 2fm, which is twice the modulation frequency fm, in accordance with the control of the control processing unit 11 and includes, for example, an oscillator and the like. The second synchronization signal generation unit 33 outputs this generated second synchronization signal SS2 to the second phase shift unit 34.

The second phase shift unit 34 is a circuit connected to the second detection unit 31 and configured to change (advance or delay) the phase of the second synchronization signal SS2 of the second synchronization signal generation unit 33 at a predetermined timing set in advance so that the second synchronization signal SS2 is synchronized with a component of the frequency 2fm, which is twice the modulation frequency fm, and includes, for example, a phase shifter and the like. The second phase shift unit 34 outputs the second synchronization signal SS2 changed to a predetermined phase to the second detection unit 31.

The second detection unit 31 is a circuit connected to the second LPF unit 32 and configured to synchronously detect the output signal of the first light reception unit 6 input from the first light reception unit 6 on the basis of the second synchronization signal SS2 input from the second phase shift unit 34 and includes, for example, a multiplier and the like or a switching element and the like. A frequency component equal to the second synchronization signal SS2, i.e. the component of the second harmonic 2fm (component of the second harmonic 2fm), which is twice the modulation frequency fm, is extracted from the output signal of the first light reception unit 6 by this synchronous detection. The second detection unit 31 outputs a synchronous detection result to the second LPF unit 32.

The second LPF unit 32 is a circuit connected to the control processing unit 11 and configured to filter the synchronous detection result input from the second detection unit 31 and cause only components equal to or below a predetermined cut-off frequency fcut to pass. The second LPF unit 32 outputs this filtering result to the control processing unit 11 as a second phase-sensitive detection result of the second phase-sensitive detection unit 9. In this embodiment, the second LPF unit 32 is configured to be able to change a low-pass band thereof, i.e. the cut-off frequency fcut, in accordance with the control of the control processing unit 11.

Such a second LPF unit 32 is, for example, a so-called integration circuit with 21^{th} and 22^{th} resistance elements R21, R22, three 21^{st} to 23^{th} capacitors C21, C22 and C23 having mutually different capacitances, a second operational amplifier OP2 and a second selection switch SW2 with one input and three outputs as shown in FIG. 3B.

An output terminal of the second detection unit 31 is connected to an inverting input terminal (−) of the second operational amplifier OP2 via the 21^{st} resistance element R21. A predetermined reference voltage (base voltage) Vref set in advance is input to a non-inverting input terminal (+) of the second operational amplifier OP2. The 22^{th} resistance element R22 is connected between the inverting input terminal (−) of the second operational amplifier OP2 and an output terminal of the second operational amplifier OP2. An input terminal of the second selection switch SW2 is connected to the inverting input terminal (−) of the second operational amplifier OP2. A 21^{st} output terminal of the second selection switch SW2 is connected to the output terminal of the second operational amplifier OP2 via the 21^{st} capacitor C21. A 22^{th} output terminal of the second selection switch SW2 is connected to the output terminal of the second operational amplifier OP2 via the 22^{th} capacitor C22. A 23^{th} output terminal of the second selection switch SW2 is connected to the output terminal of the second operational amplifier OP2 via the 23^{th} capacitor C23. Connected states between the input terminal of the second selection switch SW2 and the 21^{st} to 23^{th} output terminals are set according to a control signal of the control processing unit 11. Specifically, the second selection switch SW2 connects the input terminal to any one of the 21^{st} to 23^{th} output terminals according to the control signal of the control processing unit 11. An output (output terminal) of the second operational amplifier OP2 is an output (output terminal) of the second phase-sensitive detection unit 9.

The second LPF unit 32 having such a circuit configuration can change the cut-off frequency fcut, i.e. the low-pass band, by switching the capacitor C to be connected between the inverting input terminal (−) and the output terminal in the second operational amplifier OP2 by the second selection switch SW2. The resistance value of the 22^{th} resistance element R22 and the capacitance of each of the 21^{st} to 23^{th} capacitors C21 to C23 are appropriately set according to the change range of the modulation frequency fm.

Note that although each of the first and second LPF units 22, 32 includes three capacitors C (C11 to C13; C21 to C23) so that any one of the three can be change the cut-off frequency fcut, each of the first and second LPF units 22, 32 includes a number of capacitors C corresponding to the number of the changeable cut-off frequencies fcut.

The amplification unit 10 is a circuit connected to the AD unit 20 and configured to amplify the second output signal SG2 of the second light reception unit 7 input from the second light reception unit 7. The amplification unit 10 outputs this amplified second output signal SG2 to the control processing unit 11 via the AD unit 20.

The AD unit 20 is a circuit connected to the control processing unit 11 and configured to convert the analog second output signal SG2 output from the amplification unit 10 into a digital second output signal and output this converted digital second output signal to the control processing unit 11.

The storage unit 17 is a circuit connected to the control processing unit 11 and configured to store various predetermined programs and various pieces of predetermined data in accordance with the control of the control processing unit 11. The various predetermined programs include, for example, control processing programs such as a control program for controlling each part of the gas detection device D according to a function of each part, a detection light irradiation program for irradiating detection light frequency-modulated at the predetermined modulation frequency fm using the predetermined frequency fc as the center frequency fc while scanning the detection light along a predetermined scanning direction, a sampling program for sampling each of detection output signals of the first and second phase-sensitive detection units 8, 9 at a predetermined sampling period Sp, a gas detection program for detecting detection target gas on the basis of a sampling result of the sampling program and a distance measurement program for measuring the distance Ds to the object Ob that is irradiated with the detection light Lc and generates the first reflected light Lcr based on the detection light Lc. The various pieces of predetermined data include data necessary in executing each of the above programs, data necessary in detecting the detection target gas GA and the like. The storage unit 17 includes, for example, a ROM (Read Only Memory), which is a nonvolatile storage element, and an EEPROM (Electrically Erasable Programmable Read Only Memory), which is a rewritable nonvolatile storage element, and the like. The storage unit 17 includes a RAM (Random Access Memory) or the like serving as a so-called working memory of the control processing unit 11 for storing data and the like generated during the execution of the predetermined program.

The control processing unit 11 is a circuit configured to control each part of the gas detection device D according to the function of each part and detect the detection target gas GA. The control processing unit 11 is, for example, configured to include a CPU (Central Processing Unit) and its peripheral circuits. The control processing unit 11 is functionally provided with a control unit 12, a sampling processing unit 13, a detection processing unit 14 and a distance measurement processing unit 15 by executing the control processing program.

The control unit 12 controls each part of the gas detection device D according to the function of each part and the entire gas detection device D. For example, for detection at a plurality of mutually different detection points along the circumferential scanning direction, the control unit 12 controls the deflection unit 18 to radially irradiate each of the detection light Lc and the distance measurement light Ld in a plurality of mutually different directions along the circumferential direction (scanning direction) and successively receive the first reflected light Lcr and the second reflected light Ldr by the wavelength selection unit 5. Further, for example, the control unit 12 controls the first light source unit 1 via the first drive unit 3 so that the detection light Lc frequency-modulated at the modulation frequency fm is irradiated in the form of CW light. Further, for example, the control unit 12 controls the second light source unit 2 via the second drive unit 4 so that the distance measurement light Ld is irradiated in the form of pulsed light.

The distance measurement processing unit 15 obtains the distance Ds to the object Ob on the basis of an irradiation timing t1 of irradiating the distance measurement light Ld and a light reception timing t2 of receiving the second reflected light Ldr of the distance measurement light Ld. More specifically, the distance measurement processing unit 15 calculates a propagation time τ (=t2−t1) until the distance measurement light Ld emitted from the second light source unit 2 becomes the second reflected light Ldr at the object Ob and this second reflected light Ldr is received by the second light reception unit 7 by subtracting the irradiation timing t1 from the light reception timing t2, and obtains the distance Ds from the gas detection device D to the object Ob by multiplying half the obtained propagation time τ by a propagation speed of the distance measurement light (TOF (Time Of Fright) method). The distance measurement processing unit 15 notifies this obtained distance Ds to the control unit 12.

The sampling processing unit 13 samples the detection output signal of each of the first and second phase-sensitive detection units 8, 9 at the predetermined sampling period Sp. The sampling processing unit 13 notifies a sampling result of each sampled detection output signal to the detection processing unit 14. Note that although the sampling processing unit 13 is functionally provided in the control processing unit 11 by software in this embodiment, the sampling processing unit 13 may be a hardware circuit interposed between each of the first and second phase-sensitive detection units 8, 9 and the control processing unit 11.

The detection processing unit 14 detects the detection target gas GA on the basis of the sampling result on each detection output signal in the sampling processing unit 13. More specifically, the detection processing unit 14 detects the detection target gas GA utilizing a so-called frequency modulation method (2f detection method). As shown in FIG. 4, a light absorption spectrum of the gas has a line-symmetrical profile with respect to the frequency fc of the absorption line such as a quadratic function profile in a range near the frequency fc of the absorption line. Thus, as described above, if laser light frequency-modulated at the modulation frequency fm using the frequency fc of the absorption line as the center frequency fc is irradiated to the gas, the intensity of the laser light passed through the gas undergoes one-cycle oscillation by half-cycle oscillation on a wavelength side shorter than the center frequency fc, and undergoes one-cycle oscillation one more time by half-cycle oscillation on a wavelength side longer than the center frequency fc. As a result, the laser light passed through the gas includes an intensity component having a frequency (second harmonic) 2fm, which is twice the modulation frequency fm. Since the intensity of this component of the second harmonic 2fm is proportional to a gas concentration as understood from FIG. 4, the gas concentration can be measured by detecting this component of the second harmonic 2fm. By normalizing this component of the second harmonic 2fm by the component of the modulation frequency fm, a light receiving intensity variation (noise) caused by factors other than absorption by the detection target gas GA can be reduced. Thus, more specifically, the detection processing unit 14 detects the detection target gas GA on the basis of a first sampling result on a first detection output signal of the first phase-sensitive detection unit 8 representing the component of the modulation frequency fm and a second sampling result on a second detection output signal of the second phase-sensitive detection unit 9 representing the component of the second harmonic 2fm.

The detection processing unit 14 may detect the detection target gas GA by determining the presence or absence of the detection target gas GA, but preferably detects the detection target gas GA by obtaining a concentration thickness product in the detection target gas GA on the basis of the first reflected light Lcr received by the first light reception unit 6, i.e. the first and second sampling results on the first and second detection output signals of the first and second phase-sensitive detection units 8, 9. More specifically, a function expression, a look-up table or the like representing a correspondence relationship between a division result obtained by dividing the component of the second harmonic 2fm (second sampling result) by the component of the modulation frequency fm (first sampling result) and the concentration thickness product is obtained and stored in the storage unit 17, and the detection processing unit 14 detects the detection target gas GA by dividing the second sampling result on the second detection output signal of the second phase-sensitive detection unit 9 by the first sampling result on the first detection output signal of the first phase-sensitive detection unit 8 and converting this division result into the concentration thickness product using the function expression, the look-up table or the like.

Further preferably, since the distance Ds to the object Ob is obtained by the distance measurement processing unit 15, the detection processing unit 14 obtains the concentration thickness product as described above and detects the detection target gas GA by dividing the thus obtained concentration thickness product by the distance Ds measured by the distance measurement processing unit 15 to obtain an average gas concentration.

In this embodiment, the control unit 12 obtains a scanning speed (rotation speed (angular speed) of the deflection mirror about the axis in this example) Vs in the control of the deflection unit 18 described above, and controls the first light source unit 1 via the first drive unit 3, each of the first and second synchronization signal generation units 23, 33 and the first and second LPF units 22, 23 in the first and second phase-sensitive detection units 8, 9, and the sampling processing unit 13 on the basis of this obtained scanning speed Vs and the distance to the object Ob obtained by the distance measurement processing unit 15. Preferably, the control unit 12 controls the modulation frequency fm of the detection light Lc irradiated from the first light source unit 1 via the drive unit 3, the respective frequencies of the first and second synchronization signals of the first and second synchronization signal generation units 23, 33 and the respective cut-off frequencies fcut of the first and second LPF units 22, 23 of the first and second phase-sensitive detection units 8, 9, and the sampling period Sp of the sampling processing unit 13 on the basis of the obtained scanning speed Vs and the obtained distance to the object Ob. More preferably, the control unit 12 controls the modulation frequency fm of the detection light Lc irradiated from the first light source unit 1 via the first drive unit 3 to achieve a frequency (e.g. higher frequency) corresponding to the obtained scanning speed Vs and the obtained distance to the object Ob (fm→fm+Δf=fmc, Δf is a positive or negative value), controls the respective frequencies of the first and second synchronization signals of the first and second synchronization signal generation units 23, 33 in the first and second phase-sensitive detection units 8, 9 to correspond to the modulation frequency fmc after this frequency change, controls the respective cut-off frequencies fcut of the first and second LPF units 22, 23 in the first and second phase-sensitive detection units 8, 9 to correspond to the modulation frequency fmc after this frequency change, and controls the sampling period Sp of the sampling processing unit 13 to correspond to the modulation frequency fmc after this frequency change.

In this embodiment, as understood from the above, the control unit 12 doubles as a scanning speed acquisition unit for obtaining the scanning speed Vs and is equivalent to an example of the scanning speed acquisition unit. Note that the scanning speed Vs is stored as a predetermined value in the storage unit 17. Alternatively, the gas detection device D may include a scanning speed acquisition unit 19 for obtaining the scanning speed Vs as shown by broken line in FIG. 1. This scanning speed acquisition unit 19 may be, for example, a numeric keypad or the like for receiving and inputting the scanning speed Vs from outside. Further, for example, the scanning speed acquisition unit 19 may an angular speed meter for actually measuring an angular speed of the deflection unit 18 and obtaining the scanning speed Vs on the basis of this actually measured angular speed. Further, for example, the scanning speed acquisition unit 19 may be an angular acceleration meter for actually measuring an angular acceleration of the deflection unit 18 and obtaining the scanning speed Vs on the basis of this actually measured angular acceleration.

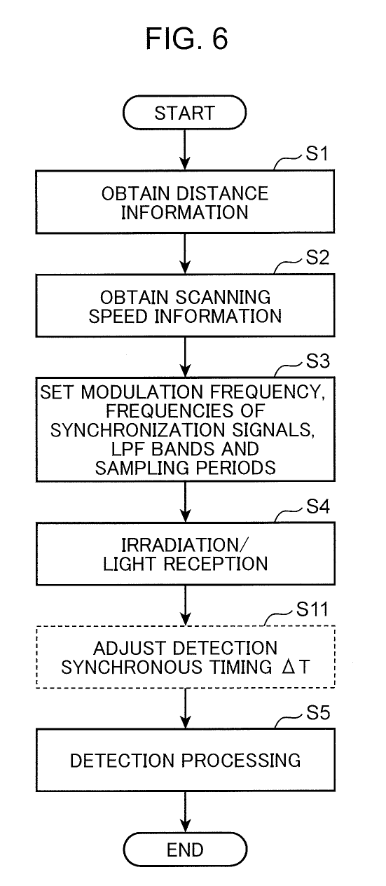

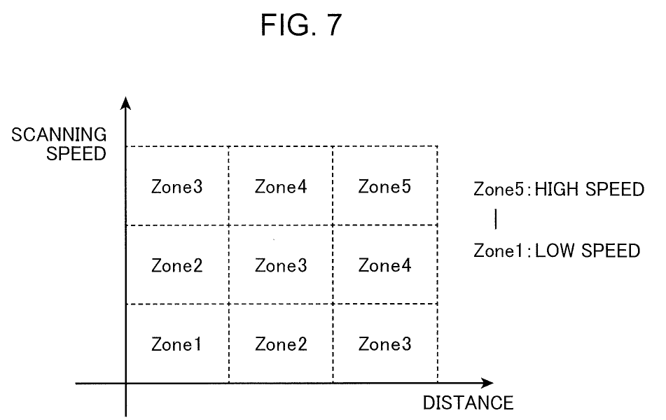

Next, the operation of the gas detection device D is described. FIG. 5 are diagrams showing a relationship between a scanning speed and a measurement point density and a relationship between a distance and the measurement point density. FIG. 5A is the diagram showing the relationship between the scanning speed and the measurement point density, and FIG. 5B is the diagram showing the relationship between the distance and the measurement point density. FIG. 6 is a flow chart showing the operation of the gas detection device in the embodiment. FIG. 7 is a graph showing a relationship between the scanning speed and the modulation frequency and a relationship between the distance and the modulation frequency. A horizontal axis of FIG. 7 represents the distance and a vertical axis thereof represents the scanning speed (angular speed, angular acceleration).

First, the relationship between the scanning speed and the measurement point density and the relationship between the distance and the measurement point density are described. In the relationship between the scanning speed and the measurement point density, if the scanning speed Vs is increased in the case of measurement by scanning the detection light Lc, a detection interval along the scanning direction becomes larger than that before an increase of the scanning speed Vs as shown in FIG. 5A. Thus, a density of the detection points (measurement points) becomes coarse. Note that, in FIG. 5A, the detection points before speeding up are indicated by white circles (∘) and the detection points after speeding up are indicated by black circles (•). Further, in an example shown in FIG. 5A, the detection light Lc is radially irradiated with an irradiation receiving point of the detection light Lc as a center and scanned with a circumferential direction intersecting with a radiation direction as a scanning direction. However, the same holds true also when the detection light Lc moves along the scanning direction. Due to this coarse detection point density, if the sampling period Sp (sampling interval, sampling frequency) along the scanning direction is shortened (shorter interval, higher frequency) according to the increase of the scanning speed Vs, the coarsening (sparseness) of the density of the measurement points is reduced. For example, in the case of doubling the scanning speed Vs, the density of the measurement points is substantially equal before and after the increase of the scanning speed Vs if the sampling period Sp along the scanning direction is halved. Note that, in FIG. 5A, the detection points at a shorter sampling period after speeding up are indicated by X. However, in this case, detection accuracy is degraded (reduced) since the number of light reception signal samples at one measurement point is reduced.

On the other hand, in the case where the detection light Lc is radially irradiated with the irradiation receiving point of the detection light Lc as a center and detection is made by scanning the detection light Lc with the circumferential direction intersecting the radiation direction as the scanning direction, a detection interval along the scanning direction (circumferential direction) becomes wider than that before the distance extension if the distance Ds to the object extends. Thus, a situation similar to the above occurs as the scanning speed Vs is increased. As a result, the number of light reception signal samples at one measurement point is reduced, wherefore detection accuracy is degraded (reduced).

Thus, in the gas detection device D in this embodiment, the control unit 12 controls each of the first light source unit 1 via the first drive unit 3, the first and second synchronization signal generation units 23, 33 and the first and second LPF units 22, 32 in the first and second phase-sensitive detection units 8, 9 and the sampling processing unit 13 on the basis of the scanning speed Vs and the distance Ds to the object Ob as follows, thereby reducing the degradation of detection accuracy associated with the increase of the scanning speed Vs and the extension of the distance Ds to the object.

More specifically, the gas detection device D operates as follows. When being started, the gas detection device D initializes each of necessary parts and starts the operation thereof. Further, by executing the control processing program, the control unit 12, the sampling processing unit 13, the detection processing unit 14 and the distance measurement processing unit 15 are functionally configured in the control processing unit 11. Then, the gas detection device D operates as follows during scanning.

In FIG. 6, the control unit 12 of the control processing unit 11 first obtains the distance Ds to the object (Si). More specifically, the control unit 12 controls the second light source unit 2 via the second drive unit 4 so that the distance measurement light Ld is emitted in the form of pulsed light from the second light source unit 2, the second light reception unit 7 receives the second reflected light Ldr of the distance measurement light Ld via the wavelength selection unit 5 and outputs the second output signal SG2 thereof obtained by photoelectrically converting the second reflected light Ldr to the control processing unit 11 via the amplification unit 10 and the AD unit 20, and the control processing unit 11 obtains the distance Ds to the object Ob by the distance measurement processing unit 15. More specifically, the distance measurement light Ld emitted from the second light source unit 2 is incident on the deflection unit 18, deflected by the deflection unit 18 and irradiated to the object Ob. The object Ob irradiated with the distance measurement light Ld generates the second reflected light Ldr based on the distance measurement light Ld, for example, by specular reflection, scattered reflection or the like. This second reflected light Ldr is incident on the deflection unit 18, deflected to the wavelength selection unit 5 by the deflection unit 18 and received by the second light reception unit 7 via the wavelength selection unit 5. The second light reception unit 7 outputs the second output signal SG2 thereof obtained by photoelectrically converting the second reflected light Ldr to the control processing unit 11 while having the second output signal SG2 amplified in the amplification unit 10 and digitized in the AD unit. In the control processing unit 11, the distance measurement processing unit 15 obtains a propagation time τ (=t2−t1) until the second reflected light Ldr of the distance measurement light Ld is received by the second light reception unit 7 after the distance measurement light Ld in the form of pulsed light is emitted from the second light source unit 2 by subtracting the irradiation timing t1 from the light reception timing t2, and obtains the distance Ds from the gas detection device D to the object Ob by multiplying half the thus obtained propagation time τ by a propagation speed (speed of light in this embodiment) of the distance measurement light Ld.

Subsequently, the control unit 12 obtains the scanning speed Vs (S2). In this embodiment, the control unit 12 obtains the scanning speed Vs used in the control of the deflection unit 18. Note that, as described above, the scanning speed Vs may be obtained by being received from outside and input by the scanning speed acquisition unit 19 or may be obtained by actually measuring the angular speed of the deflection unit 18 by the scanning speed acquisition unit 19 such as an angular speed meter or an angular acceleration meter.

Subsequently, the control unit 12 controls each of the first light source unit 1 via the first drive unit 3, the first and second synchronization signal generation units 23, 33 and the first and second LPF units 22, 32 in the first and second phase-sensitive detection units 8, 9 and the sampling processing unit 13 on the basis of the distance Ds to the object Ob obtained in processing 51 and the scanning speed Vs obtained in processing S2 (S3). More specifically, the control unit 12 controls the modulation frequency fm of the detection light Lc irradiated from the first light source unit 1 via the first drive unit 3 to achieve a frequency corresponding to the distance Ds to the object Ob obtained in processing 51 and the scanning speed Vs obtained in processing S2 (fm→fmc), controls the respective frequencies of the first and second synchronization signals of the first and second synchronization signal generation units 23, 33 in the first and second phase-sensitive detection units 8, 9 to correspond to the modulation frequency fmc after this frequency change, controls the respective cut-off frequencies fcut of the first and second LPF units 22, 23 in the first and second phase-sensitive detection units 8, 9 to correspond to the modulation frequency fmc after this frequency change, and controls the sampling period Sp of the sampling processing unit 13 to correspond to the modulation frequency fmc after this frequency change.

More specifically, in this embodiment, a correspondence relationship of the scanning speed Vs, the distance Ds, the modulation frequency fmc, the cut-off frequencies fcut (first cut-off frequency fcut1 of the first LPF unit 22 and second cut-off frequency fcut2 of the second LPF unit 32) and the sampling periods Sp (first sampling period Sp1 for the output of the first phase-sensitive detection unit 8 and second sampling period Sp2 for the output of the second phase-sensitive detection unit 9) is stored in advance in the storage unit 17. The control unit 12 first obtains the modulation frequency fmc, the cut-off frequencies fcut (fcut1, fcut 2) and the sampling periods Sp (Sp1, Sp2) in the above correspondence relationship from the distance Ds to the object Ob obtained in processing 51 and the scanning speed Vs obtained in processing S2. Then, the control unit 12 controls the first light source unit 1 via the first drive unit 3 to irradiate the detection light Lc frequency-modulated at this obtained modulation frequency fmc, controls the first synchronization signal generation unit 23 of the first phase-sensitive detection unit 8 to generate the first synchronization signal SS1 having this obtained modulation frequency fmc, controls the second synchronization signal generation unit 33 of the second phase-sensitive detection unit 9 to generate the second synchronization signal SS2 having a frequency 2fmc, which is twice this obtained modulation frequency fmc, controls the first LPF unit 22 by switching the first selection switch SW1 to achieve this obtained first cut-off frequency fcut1, controls the second LPF unit 32 by switching the second selection switch SW2 to achieve this obtained the second cut-off frequency fcut2, and controls the sampling processing unit 13 to sample the first detection output signal output from the first phase-sensitive detection unit 8 at the first sampling period Sp1 and sample the second detection output signal output from the second phase-sensitive detection unit 9 at the second sampling period Sp2.

In an example, as shown in FIG. 7, the above correspondence relationship is divided into nine zones according to the distance and the scanning speed, any ones of first to fifth mutually different modulation frequencies fmc, first to fifth mutually different cut-off frequencies fcut (first cut-off frequencies fcut1 of the first LPF unit 22 and second cut-off frequencies fcut2 of the second LPF unit 32) and first to fifth mutually different sampling periods SP (first sampling periods Sp1 for the output of the first phase-sensitive detection unit 8 and second sampling periods Sp2 for the output of the second phase-sensitive detection unit 9) are assigned to each zone. More specifically, the distance Ds is divided into three, i.e. short distance (0≤Ds1≤Ds<Ds2), middle distance (Ds2≤Ds<Ds3) and long distance (Ds3≤Ds<Ds4) from the gas detection device D, and the scanning speed Vs is divided into three, i.e. low speed (0≤Vs1≤Vs<Vs2), medium speed (Vs2≤Vs<Vs3) and high speed (Vs3≤Vs<Vs4). By a 3×3 matrix of these three short distance, middle distance and long distance and three low speed, medium speed and high speed, the above correspondence relationship is divided into the nine zones. A first type (Zone 1), a second type (Zone 2) and a third type (Zone 3) are assigned in the respective zones of the short distance, the middle distance and the long distance at the low speed. The second type (Zone 2), the third type (Zone 3) and a fourth type (Zone 4) are assigned in the respective zones of the short distance, the middle distance and the long distance at the medium speed. The third type (Zone 3), the fourth type (Zone 4) and a fifth type (Zone 5) are assigned in the respective zones of the short distance, the middle distance and the long distance at the high speed. The modulation frequency fmc is set to be successively higher from the first type to the fifth type (modulation frequency fmc1 of the first type <modulation frequency fmc2 of the second type <modulation frequency fmc3 of the third type <modulation frequency fmc4 of the fourth type <modulation frequency fmc5 of the fifth type). The first cut-off frequency fcut1 of the first LPF unit 22 is set to be successively higher from the first type to the fifth type (cut-off frequency fcut11 of the first type <cut-off frequency fcut12 of the second type <cut-off frequency fcut13 of the third type <cut-off frequency fcut14 of the fourth type <cut-off frequency fcut15 of the fifth type). The second cut-off frequency fcut2 of the second LPF unit 32 is set to be successively higher from the first type to the fifth type (cut-off frequency fcut21 of the first type <cut-off frequency fcut22 of the second type <cut-off frequency fcut23 of the third type <cut-off frequency fcut24 of the fourth type <cut-off frequency fcut25 of the fifth type). The first sampling period Sp1 for the output of the first phase-sensitive detection unit 8 is set to be successively shorter from the first type to the fifth type (sampling period Sp11 of the first type >sampling period Sp12 of the second type >sampling period Sp13 of the third type >sampling period Sp14 of the fourth type >sampling period Sp15 of the fifth type). The second sampling period Sp2 for the output of the second phase-sensitive detection unit 9 is set to be successively shorter from the second type to the fifth type (sampling period Sp21 of the first type >sampling period Sp22 of the second type >sampling period Sp23 of the third type >sampling period Sp24 of the fourth type >sampling period Sp25 of the fifth type).

If the modulation frequency fm (=fmc) of the detection light Lc, the frequency fmc and the first cut-off frequency fcut1 of the first synchronization signal in the first phase-sensitive detection unit 8, the frequency 2fmc and the second cut-off frequency fcut2 of the second synchronization signal in the second phase-sensitive detection unit 9 and the first and second sampling periods Sp1, Sp2 of the sampling processing unit 13 are set by processing S3 in this way, the control unit 12 irradiates the detection light Lc, receives the first reflected light Lcr of the detection light Lc, performs the phase-sensitive detection and samples that detection result (S4). More specifically, by the control of the control unit 12, the first light source unit 1 irradiates the detection light Lc frequency-modulated at the modulation frequency fmc using the center frequency fc as a center in the form of continuous light, the first reflected light Lcr of this detection light Lc is received by the first light reception unit 6 via the wavelength selection unit 5, the first light reception unit 6 outputs the first output signal SG1 thereof obtained by photoelectrically converting the first reflected light Lcr to each of the first and second phase-sensitive detection units 8, 9, and each of the first and second phase-sensitive detection units 8, 9 performs the phase-sensitive detection of the first output signal SG1 and outputs the first or second detection output signals to the control processing unit 11 by the control of the control unit 12, and the sampling processing unit 13 samples the first detection output signal from the first phase-sensitive detection unit 8 at the first sampling period Sp1 and samples the second detection output signal from the second phase-sensitive detection unit 9 at the second sampling period Sp2 by the control of the control unit 12.

Then, the control processing unit 11 detects the detection target gas GA on the basis of the sampling result of each detection output signal in the sampling processing unit 13 by the detection processing unit 14 and outputs this detection result to another instrument (S5). In this embodiment, the detection processing unit 14 detects the detection target gas by dividing the second sampling result (component of the second harmonic 2fm) for the second detection output signal of the second phase-sensitive detection unit 9 by the first sampling result (component of the modulation frequency fmc) for the first detection output signal of the first phase-sensitive detection unit 8 and converting this division result into the concentration thickness product using, for example, the look-up table or the like described above and stored in the storage unit 17 in advance. Preferably, the detection processing unit 14 may further obtain an average gas concentration by dividing this obtained concentration thickness product by the distance Ds obtained by the distance measurement processing unit 15.

Such an operation is repeatedly performed during scanning.

Note that, as understood from above, the first light source unit 1, the first drive unit 3, the deflection unit 18 and the control processing unit 11 correspond to an example of a detection light source unit, and the second light source unit 2, the second drive unit 4, the deflection unit 18, the wavelength selection unit 5, the second light reception unit 7, the amplification unit 10, the AD unit 20 and the control processing unit 11 correspond to an example of a distance measurement unit.

As described above, since the control unit 12 controls each of the detection light Lc of the first light source unit 1, the first and second synchronization signal generation units 23, 33 and the first and second LPF units 22, 32 in the first and second phase-sensitive detection units 8, 9 and the sampling processing unit 13 on the basis of the scanning speed Vs and the distance Ds in the gas detection device D and a gas detection method implemented in this according to this embodiment, even if the distance Ds to the object Ob is extended while the scanning speed is increased, each of the modulation frequency fm of the detection light Lc, the frequencies of the first and second synchronization signals SS1, SS2, the first and second cut-off frequencies fcut1, fcut2 of the first and second LPF units 22, 32 and the first and second sampling periods Sp1, Sp2 of the sampling processing unit 13 can be controlled according to the increased scanning speed Vs and the distance Ds to the object Ob. Thus, the degradation of detection accuracy associated with the increase of the scanning speed Vs and the extension of the distance Ds to the object Ob can be reduced.

Since the first optical axis of the detection light Lc and the second optical axis of the distance measurement light Ld are parallel to each other in the above gas detection device D and gas detection method, the interference of the detection light Lc and the distance measurement light Ld can be prevented. Thus, the gas can be more accurately detected. Particularly, the first and second optical axes are proximately parallel to each other, more preferably most proximately parallel without overlapping each other, whereby such gas detection device D and gas detection method can precisely measure the distance to the object Ob while preventing mutual interference. Thus, the gas can be more accurately detected.

Since the first light receiving sensitivity wavelength band of the first light reception unit 6 and the second light receiving sensitivity wavelength band of the second light reception unit 7 are different from each other by the predetermined sensitivity threshold value or larger in the above gas detection device D and gas detection method, the reception of the second reflected light Ldr by the first light reception unit 6 can be reduced and the reception of the first reflected light Lcr by the second light reception unit 7 can be reduced. Thus, the above gas detection device D and gas detection method can reduce noise caused by the reception of the second reflected light Ldr by the first light reception unit 6 and noise caused by the reception of the first reflected light Lc by the second light reception unit 7, wherefore the gas can be more accurately detected. Further, because of this, the above gas detection device D and gas detection method have a possibility of being able to omit a filter for reducing the reception of the second reflected light Ldr in the first light reception unit 6 and a filter for reducing the reception of the first reflected light Lcr in the second light reception unit 7 depending on accuracy required for the above gas detection device D and gas detection method.

Since the laser light having a wavelength of 1653 nm, which is an R(3) line, or having a wavelength of 1651 nm, which is an R(4) line, at which methane is most strongly absorbed is used as the detection light Lc in the above gas detection device D and gas detection method, methane can be suitably detected as the detection target gas GA. Further, by setting the wavelength of the detection light Lc at 1653 nm or 1651 nm, an InGaAs light receiving element having light receiving sensitivity to the 1600 nm wavelength band can be used as the first light reception unit 6 in the above gas detection device D and gas detection method.

Since the wavelength of the distance measurement light Ld is set at any one of wavelengths in the wavelength range of 800 nm to 1000 nm in the above gas detection device D and gas detection method, a Si light receiving element having light receiving sensitivity to this wavelength range of 800 nm to 1000 nm can be suitably utilized as the second light reception unit 7.

A system for detecting the detection target gas GA and a system for measuring a distance are independent separate systems in the above gas detection device D and gas detection method.

Note that although the first optical axis of the detection light Lc and the second optical axis of the distance measurement light Ld are proximately parallel to each other in the above embodiment, the first optical axis of the detection light Lc and the second optical axis of the distance measurement light Ld may be substantially coaxial. Specifically, the first and second light source units 1, 2 are so arranged with respect to the deflection unit 18 that the first optical axis of the detection light Lc and the second optical axis of the distance measurement light Ld are substantially coaxial. Since the first and second optical axes are substantially coaxial with each other according to this, such a gas detection device D can reliably measure the distance Ds to the object Ob that generates the reflected light Lcr, wherefore the gas can be more accurately detected.

Further, although the control unit 12 controls each of the detection light Lc of the first light source unit 1, the first and second synchronization signal generation units 23, 33 and the first and second LPF units 22, 32 of the first and second phase-sensitive detection units 8, 9 and the sampling processing unit 13 on the basis of the scanning speed Vs and the distance Ds in the above embodiment, the control unit 12 may control each of the detection light Lc of the first light source unit 1, the first and second synchronization signal generation units 23, 33 and the first and second LPF units 22, 32 of the first and second phase-sensitive detection units 8, 9 and the sampling processing unit 13 on the basis of the scanning speed Vs. In this case, in FIG. 7, the respective zones of the short distance, the middle distance and the long distance at the low speed are, for example, used as a correspondence relationship of the scanning speed Vs, the modulation frequency fmc, the cut-off frequencies fcut (fcut1, fcut2) and the sampling periods Sp (Sp1, Sp2). Further, the respective zones of the short distance, the middle distance and the long distance at the medium speed are, for example, used as the above correspondence relationship. Further, the respective zones of the short distance, the middle distance and the long distance at the high speed are, for example, used as the above correspondence relationship. According to this, even if the scanning speed is increased, each of the modulation frequency fm of the detection light Lc, the frequencies of the first and second synchronization signals SS1, SS2, the first and second cut-off frequencies fcut1, fcut2 of the first and second LPF units 22, 32 and the first and second sampling periods Sp1, Sp2 of the sampling processing unit 13 can be controlled according to the increased scanning speed Vs. Thus, the degradation of detection accuracy associated with the increase of the scanning speed Vs can be reduced.

Alternatively, the control unit 12 may control each of the detection light Lc of the first light source unit 1, the first and second synchronization signal generation units 23, 33 and the first and second LPF units 22, 32 of the first and second phase-sensitive detection units 8, 9 and the sampling processing unit 13 on the basis of the distance Ds. In this case, in FIG. 7, the respective zones of the low speed, the medium speed and the high speed at the short distance are, for example, used as a correspondence relationship of the distance Ds, the modulation frequency fmc, the cut-off frequencies fcut (fcut1, fcut2) and the sampling periods Sp (Sp1, Sp2). Further, the respective zones of the low speed, the medium speed and the high speed at the middle distance are, for example, used as the above correspondence relationship. Further, the respective zones of the low speed, the medium speed and the high speed at the long distance are, for example, used as the above correspondence relationship. According to this, even if the distance Ds to the object Ob is extended, each of the modulation frequency fm of the detection light Lc, the frequencies of the first and second synchronization signals SS1, SS2, the first and second cut-off frequencies fcut1, fcut2 of the first and second LPF units 22, 32 and the first and second sampling periods Sp1, Sp2 of the sampling processing unit 13 can be controlled according to the distance Ds to the object Ob. Thus, the degradation of detection accuracy associated with the extension of the distance Ds to the object Ob can be reduced.

Further, if the first and second light source units 1, 2 include a semiconductor laser in these embodiments described above, a temperature sensor, a Peltier element or the like may be, for example, provided for stable operation of the semiconductor laser and the semiconductor laser may be temperature-controlled.

Further, in these embodiments described above, the gas detection device D may further include a first band-pass filter for transmitting light in a predetermined wavelength band including the wavelength of the reflected light Lcr of the detection light Lc on an incident side of the first light reception unit 6 to reduce noise. Similarly, the gas detection device D may include a second band-pass filter for transmitting light in a predetermined wavelength band including the wavelength of the reflected light Ldr of the distance measurement light Ld on an incident side of the second light reception unit 7 to reduce noise.

Further, in these embodiments described above, the first and second phase-sensitive detection units 8, 9 may be functionally configured into DSPs (Digital Signal Processors) or the like and the phase-sensitive detection may be performed by a digital signal processing. In this case, the first output signal SG1 of the first light reception unit 6 is input to the DSPs or the like via an analog-digital converter.

Further, in these embodiments described above, the gas detection device D may further include a timing adjustment unit for adjusting a synchronous detection timing of a phase-sensitive detection unit on the basis of the actually measured distance Ds to the object Ob. For example, the gas detection device D is functionally further provided with a timing adjustment processing unit 16 for adjusting synchronous detection timings of the first and second phase-sensitive detection units 8, 9 on the basis of the distance Ds to the object Ob obtained by the distance measurement processing unit 15 as shown by broken line in FIG. 1.

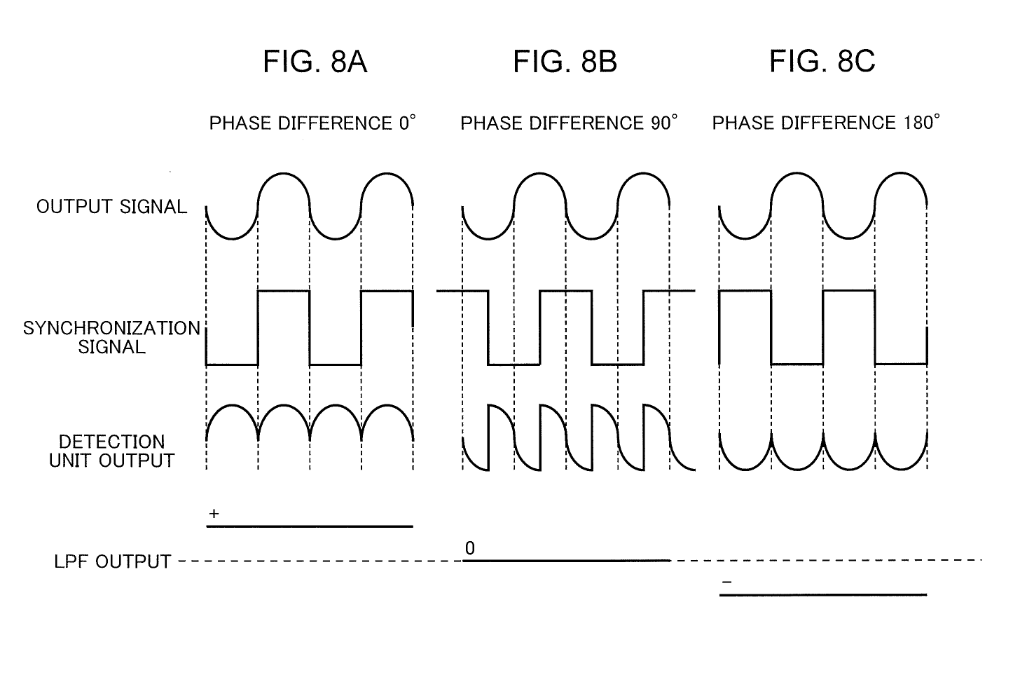

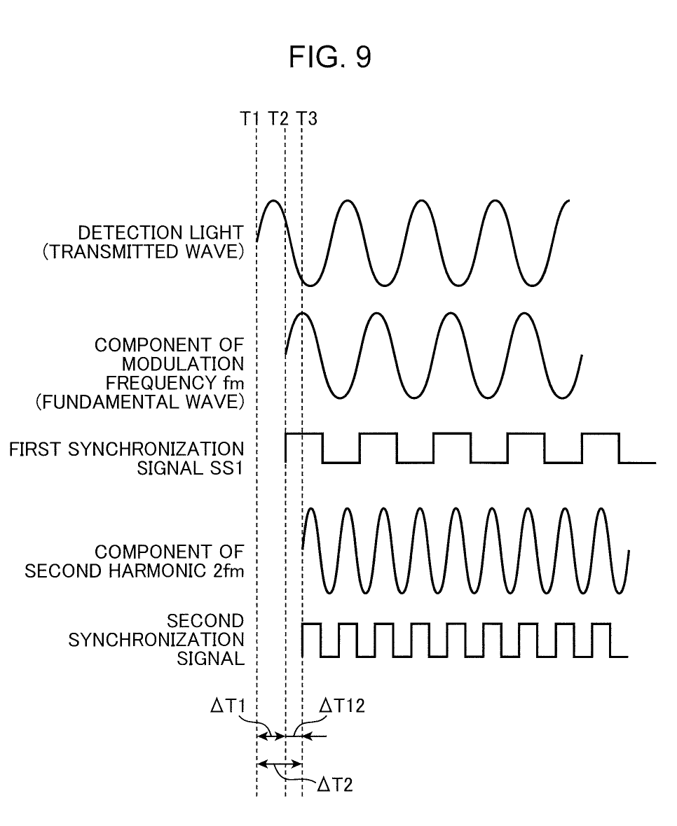

FIG. 8 are graphs showing a detection synchronous timing of a synchronization signal in response to an output signal in the first and second phase-sensitive detection units. FIG. 8A shows a case where a phase difference between the output signal and the synchronization signal is 0°, FIG. 8B shows a case where the phase difference between the output signal and the synchronization signal is 90° and FIG. 8C shows a case the phase difference between the output signal and the synchronization signal is 0°. In each of FIGS. 8A to 8C, the output signal, the synchronization signal, a detection unit output and an LPF unit output are respectively shown successively from top to bottom, a horizontal axis represents time and a vertical axis represents a signal level (signal intensity). FIG. 9 is a chart showing the adjustment of a detection synchronous timing of a gas detection device in a modification. In FIG. 9, the detection light (transmitted wave) Lc, the component of the modulation frequency (fundamental wave) fm, the first synchronization signal SS1, the component of the second harmonic 2fm and the second synchronization signal SS2 are respectively shown successively from top to bottom, a horizontal axis represents time and a vertical axis represents a signal level (signal intensity).

First, the significance of the detection synchronous timing (phase adjustment) in the first and second phase-sensitive detection units 8, 9 is described. In the phase-sensitive detection, the detection output signal (LPF unit output) thereof differs depending on the phase difference between the output signal to be detected and the synchronization signal as shown in FIG. 8. If the phase difference between the output signal and the synchronization signal is 0° (i.e. the output signal and the synchronization signal are synchronized (locked)) with each other), the detection unit can properly detect the output signal and a proper output is obtained from the LPF unit as shown in FIG. 8A. On the other hand, for example, if the phase difference between the output signal and the synchronization signal is 90° or 180° (i.e. the output signal and the synchronization signal are not synchronized (locked)), the detection unit cannot properly detect the output signal and a proper output cannot be obtained from the LPF unit as shown in FIGS. 8B and 8C. Thus, in the phase-sensitive detection, the phase of the synchronization signal needs to be adjusted such that the phase difference between the output signal and the synchronization signal becomes 0°.

In the frequency modulation method (2f detection method), if the modulation frequency fm is increased, the phase of a synchronization signal is delayed due to a propagation time of detection light. If a frequency obtained by increasing the modulation frequency fm is about several kHz or 10 kHz, the degradation of detection accuracy caused by this phase delay is inconspicuous (not problematic) even if synchronization is performed at a predetermined timing set in advance. However, if the modulation frequency fm is further increased for faster detection, the phase delay of the synchronization signal caused by the propagation time becomes larger and the influence of the propagation time is large. For example, when the phase delay is about 1° at a relatively low modulation frequency (e.g. 10 kHz) between equidistant objects Ob, the phase delay is about 10° if the modulation frequency fm is set ten times as high (100 kHz in the above example).

Thus, the aforementioned timing adjustment processing unit 16 is further provided. Since such a gas detection device D actually measures the distance Ds to the object Ob, a propagation time of the detection light Lc and the first reflected light Lcr thereof can be obtained and the synchronous detection timing based on this propagation time can be obtained. Then, this gas detection device D adjusts the synchronous detection timings of the first and second phase-sensitive detection units 8, 9 using this obtained synchronous detection timing, wherefore the degradation of detection accuracy can be reduced even if the modulation frequency fm (fmc) is further increased.

More specifically, the first light reception unit 6 receives the first reflected light Lcr generated at the object Ob from the detection light Lc irradiated in the form of CW light from the gas detection device D and having propagated to the object Ob, and having propagated back to the gas detection device D, and outputs the first output signal SG1. Thus, a timing at which the phase of the component of the modulation frequency fm (fmc) included in the first output signal SG1 output from the first light reception unit 6 becomes 0° (timing at which an amplitude becomes 0 when changing from negative to positive in the component of the modulation frequency fm (fmc)) is delayed from a timing at which the phase of the detection light Lc becomes 0° (timing at which the frequency of the frequency-modulated detection light Lc becomes the center frequency fc) by a propagation time ΔT1 for a distance 2Ds reciprocating to and from the object Ob (first delay time ΔT1) as shown in FIG. 9. A timing at which the phase of the component of the second harmonic 2fm included in the first output signal SG1 output from the first light reception unit 6 becomes 0° (timing at which an amplitude becomes 0 when changing from negative to positive in the component of the second harmonic 2fm) is also delayed from the timing at which the phase of the detection light Lc becomes 0° by the propagation time (delay time) ΔT1. In this embodiment, as shown in FIG. 9, an adjustment delay time ΔT12 set in advance in consideration of the influences of a delay in the circuit, a center deviation of the frequency modulation, and the like is added to the propagation time (delay time) ΔT1. Specifically, the timing at which the phase of the component of the second harmonic 2fm included in the first output signal SG1 output from the first light reception unit 6 becomes 0° is adjusted by a second delay time ΔT2=ΔT1+ΔT12.

Accordingly, to synchronously detect the component of the modulation frequency fm (fmc) included in the first output signal SG1 output from such a first light reception unit 6, the timing adjustment processing unit 16 obtains the first delay time ΔT1 by obtaining the propagation time ΔT1 for the distance 2Ds reciprocating to and from the object Ob from the distance Ds to the object Ob obtained by the distance measurement processing unit 15, and controls the first phase shift unit 24 by outputting a first phase adjustment signal for controlling the first phase shift unit 24 to the first phase shift unit 24 so that the first synchronization signal SS1 reaching a phase of 0° (the rise of a pulse) at a timing delayed from the timing at which the phase of the detection light Lc becomes 0° by the first delay time ΔT1 is output to the first detection unit 21. This causes the component of the modulation frequency fm (fmc) and the first synchronization signal SS1 to synchronize with each other (timing at which the amplitude becomes 0 when changing from negative to positive in the component of the modulation frequency fm (fmc)=pulse rise timing in the first output signal SG1) in the first phase-sensitive detection unit 8, and the component of the modulation frequency fm (fmc) included in the first output signal SG1 is detected and output from the first phase-sensitive detection unit 8 to the control processing unit 11. Similarly, to synchronously detect the component of the second harmonic 2fm (2fmc) included in the first output signal SG1 output from such a first light reception unit 6, the timing adjustment processing unit 16 obtains the second delay time ΔT2 (=ΔT1+ΔT12) by obtaining the propagation time ΔT1 for the distance 2Ds reciprocating to and from the object Ob from the distance Ds to the object Ob obtained by the distance measurement processing unit 15, and controls the second phase shift unit 34 by outputting a second phase adjustment signal for controlling the second phase shift unit 34 to the second phase shift unit 34 so that the second synchronization signal SS2 reaching a phase of 0° (the rise of a pulse) at a timing delayed from the timing at which the phase of the detection light Lc becomes 0° by the second delay time ΔT2 is output to the second detection unit 31. This causes the component of the second harmonic 2fm (2fmc) and the second synchronization signal SS2 to synchronize with each other (timing at which the amplitude becomes 0 when changing from negative to positive in the component of the second harmonic 2fm (2fmc)=pulse rise timing in the second output signal SG2) in the second phase-sensitive detection unit 9, and the component of the second harmonic 2fm (2fmc) included in the first output signal SG1 is detected and output from the second phase-sensitive detection unit 9 to the control processing unit 11. Such processing S11 of adjusting the detection synchronous timing ΔT is, for example, performed between processing S4 and processing S5 as shown by broken line in FIG. 6.

By controlling each of the first and second phase shift units 24, 34 by the timing adjustment processing unit 16 of the control processing unit 11 in this way, the first and second synchronization signals SS1, SS2 are so adjusted on the basis of the distance Ds to the object Ob obtained by the distance measurement processing unit 15 that the first output signal SG1 and the first synchronization signal SS1 are synchronized with each other and the second output signal SG2 and the second synchronization signal SS2 are synchronized with each other.

This specification discloses various technologies as described above. Out of those, the main technologies are summarized below.

A gas detection device according to one aspect is a gas detection device for detecting gas and includes a detection light source unit for irradiating detection light frequency-modulated using a predetermined frequency as a center frequency while scanning the detection light along a predetermined scanning direction, a detection light reception unit for receiving reflected light of the detection light by an object, a phase-sensitive detection unit for performing a phase-sensitive detection of a light reception output signal of the detection light reception unit, a sampling unit for sampling a detection output signal of the phase-sensitive detection unit, a gas detection unit for detecting gas between the gas detection device and the object on the basis of a sampling result of the sampling unit, a scanning speed acquisition unit for obtaining a scanning speed of the detection light source unit, and a control unit for controlling the detection light source unit such that the detection light is frequency-modulated at a higher modulation frequency as the scanning speed obtained by the scanning speed acquisition unit becomes faster. Preferably, in the above gas detection device, the phase-sensitive detection unit includes a detection unit for synchronously detecting the light reception output signal of the detection light reception unit using a synchronization signal, and the control unit changes the synchronization signal on the basis of the scanning speed obtained by the scanning speed acquisition unit. Preferably, in the above gas detection device, the phase-sensitive detection unit includes a low-pass filter unit to which an output signal of the detection unit is input and by which components having a higher frequency than a cut-off frequency are reduced, and the control unit changes the cut-off frequency on the basis of the scanning speed obtained by the scanning speed acquisition unit. Preferably, in the above gas detection device, the control unit controls the sampling unit to sample at a shorter period as the scanning speed obtained by the scanning speed acquisition unit becomes faster. Preferably, in another aspect, a gas detection device includes a detection light source unit for irradiating detection light frequency-modulated at a predetermined modulation frequency using a predetermined frequency as a center frequency while scanning the detection light along a predetermined scanning direction, a light reception unit for receiving reflected light of the detection light, a phase-sensitive detection unit for performing a phase-sensitive detection of a light reception output signal of the light reception unit, a sampling unit for sampling a detection output signal of the phase-sensitive detection unit at a predetermined sampling period, a gas detection unit for detecting detection target gas on the basis of a sampling result of the sampling unit, a scanning speed acquisition unit for obtaining a scanning speed of the detection light source unit, and a control unit for controlling each of the detection light source unit, the phase-sensitive detection unit and the sampling unit on the basis of the scanning speed obtained by the scanning speed acquisition unit, the phase-sensitive detection unit includes a synchronization signal generation unit for generating a synchronization signal having a frequency, which is twice the modulation frequency, a detection unit for synchronously detecting a light reception output signal of the light reception unit using the synchronization signal of the synchronization signal generation unit and a low-pass filter unit for filtering a synchronous detection output signal of the detection unit, and the control unit controls each of the detection light source unit, the synchronization signal generation unit and the low-pass filter unit of the phase-sensitive detection unit and the sampling unit on the basis of the scanning speed obtained by the scanning speed acquisition unit. Preferably, in the above gas detection device, the control unit controls each of the modulation frequency of the detection light source unit, the frequency of the synchronization signal in the synchronization signal generation unit of the phase-sensitive detection unit, the cut-off frequency in the low-pass filter unit of the phase-sensitive detection unit and the sampling period of the sampling unit on the basis of the scanning speed obtained by the scanning speed acquisition unit. More preferably, in the above gas detection device, the control unit controls the modulation frequency of the detection light source unit to achieve a frequency (e.g. higher frequency) corresponding to the scanning speed obtained by the scanning speed acquisition unit, the frequency of the synchronization signal in the synchronization signal generation unit of the phase-sensitive detection unit to correspond to the modulation frequency after a frequency change, the cut-off frequency in the low-pass filter unit of the phase-sensitive detection to correspond to the modulation frequency after the frequency change and the sampling period of the sampling unit to correspond to the modulation frequency after the frequency change. Preferably, in the above gas detection device, the detection light source unit includes a light source unit for irradiating detection light frequency-modulated at a predetermined modulation frequency using a predetermined frequency as a center frequency, and a deflection unit for irradiating the detection light emitted from the light source unit while scanning the detection light along a scanning direction. In terms of detecting detection target gas by a frequency modulation method (2f detection method), the phase-sensitive detection unit includes a first phase-sensitive detection unit for performing a phase-sensitive detection of an output signal of the light reception unit on the basis of the predetermined modulation frequency and a second phase-sensitive detection unit for performing a phase-sensitive detection of the output signal of the light reception unit on the basis of a frequency, which is twice the predetermined modulation frequency, and the control unit controls each of a first low-pass filter unit of the first phase-sensitive detection unit and a second low-pass filter unit of the second phase-sensitive detection unit on the basis of the scanning speed obtained by the scanning speed acquisition unit. In terms of obtaining a concentration thickness product in the detection target gas, the gas detection unit preferably detects the detection target gas by obtaining the concentration thickness product in the detection target gas on the basis of the sampling result of the sampling unit in the above gas detection device.

Since the control unit controls the detection light source unit on the basis of the scanning speed obtained by the scanning speed acquisition unit in such a gas detection device, the modulation frequency of the detection light can be controlled according to the increased scanning speed even if the scanning speed increased. Thus, the degradation of detection accuracy associated with the increase of the scanning speed can be reduced.

In another aspect, the above gas detection device further includes a distance measurement unit for measuring a distance to the object, and the control unit controls a sampling frequency of the sampling unit on the basis of the scanning speed obtained by the scanning speed acquisition unit and the distance to the object measured by the distance measurement unit. In terms of utilizing the distance measurement by the distance measurement unit, the gas detection unit preferably detects the detection target gas by obtaining the concentration thickness product in the detection target gas on the basis of the sampling result of the sampling unit and dividing this obtained concentration thickness product by the distance measured by the distance measurement unit to obtain an average gas concentration.

Since such a gas detection device controls the sampling frequency of the sampling unit on the basis of the scanning speed obtained by the scanning speed acquisition unit and the distance to the object measured by the distance measurement unit, the degradation of detection accuracy associated with the increase of the scanning speed can be reduced.

A gas detection device according to another aspect is a gas detection device for detecting gas and includes a detection light source unit for irradiating detection light frequency-modulated using a predetermined frequency as a center frequency while scanning the detection light along a predetermined scanning direction, a detection light reception unit for receiving reflected light of the detection light by an object, a phase-sensitive detection unit for performing a phase-sensitive detection of a light reception output signal of the detection light reception unit, a sampling unit for sampling a detection output signal of the phase-sensitive detection unit, a gas detection unit for detecting gas between the gas detection device and the object on the basis of a sampling result of the sampling unit, a distance measurement unit for measuring a distance to the object, and a control unit for controlling the detection light source unit such that the detection light is frequency-modulated at a higher modulation frequency as the distance to the object measured by the distance measurement unit becomes longer. Preferably, in another aspect, a gas detection device includes a detection light source unit for irradiating detection light frequency-modulated at a predetermined modulation frequency using a predetermined frequency as a center frequency while scanning the detection light along a predetermined scanning direction, a light reception unit for receiving reflected light of the detection light, a phase-sensitive detection unit for performing a phase-sensitive detection of a light reception output signal of the light reception unit, a sampling unit for sampling a detection output signal of the phase-sensitive detection unit at a predetermined sampling period, a gas detection unit for detecting detection target gas on the basis of a sampling result of the sampling unit, a distance measurement unit for measuring a distance to an object, to which the detection light is irradiated and which generates the reflected light based on the detection light, and a control unit for controlling each of the detection light source unit, the phase-sensitive detection unit and the sampling unit on the basis of the distance to the object measured by the distance measurement unit, the detection light source unit radially irradiates the detection light while scanning the detection light, the phase-sensitive detection unit includes a synchronization signal generation unit for generating a synchronization signal having a frequency, which is twice the modulation frequency, a detection unit for synchronously detecting a light reception output signal of the light reception unit using the synchronization signal of the synchronization signal generation unit, and a low-pass filter unit for filtering a synchronous detection output signal of the detection unit, the control unit controls each of the detection light source unit, the synchronization signal generation unit and the low-pass filter unit of the phase-sensitive detection unit and the sampling unit on the basis of the distance to the object measured by the distance measurement unit. Preferably, in the above gas detection device, the control unit controls each of the modulation frequency of the detection light source unit, a frequency of the synchronization signal in the synchronization signal generation unit of the phase-sensitive detection unit, a cut-off frequency in the low-pass filter unit of the phase-sensitive detection unit and the sampling period of the sampling unit on the basis of the distance to the object measured by the distance measurement unit. More preferably, in the above gas detection device, the control unit controls the modulation frequency of the detection light source unit to achieve a frequency (e.g. higher frequency) corresponding to the distance to the object measured by the distance measurement unit, the frequency of the synchronization signal in the synchronization signal generation unit of the phase-sensitive detection unit to correspond to the modulation frequency after a frequency change, the cut-off frequency in the low-pass filter unit of the phase-sensitive detection to correspond to the modulation frequency after the frequency change and the sampling period of the sampling unit to correspond to the modulation frequency after the frequency change. Preferably, in the above gas detection device, the detection light source unit includes a light source unit for irradiating detection light frequency-modulated at a predetermined modulation frequency using a predetermined frequency as a center frequency, and a deflection unit for irradiating the detection light emitted from the light source unit while scanning the detection light along a predetermined scanning direction. In terms of detecting detection target gas by the frequency modulation method (2f detection method), the phase-sensitive detection unit includes a first phase-sensitive detection unit for performing a phase-sensitive detection of an output signal of the light reception unit on the basis of the predetermined modulation frequency and a second phase-sensitive detection unit for performing a phase-sensitive detection of the output signal of the light reception unit on the basis of a frequency, which is twice the predetermined modulation frequency, and the control unit controls each of a first low-pass filter unit of the first phase-sensitive detection unit and a second low-pass filter unit of the second phase-sensitive detection unit on the basis of the distance to the object measured by the distance measurement unit. In terms of obtaining a concentration thickness product in the detection target gas, the gas detection unit preferably detects the detection target gas by obtaining the concentration thickness product in the detection target gas on the basis of the sampling result of the sampling unit in the above gas detection device. In terms of utilizing the distance measurement by the distance measurement unit, the gas detection unit preferably detects the detection target gas by obtaining the concentration thickness product in the detection target gas on the basis of the sampling result of the sampling unit and dividing this obtained concentration thickness product by the distance measured by the distance measurement unit to obtain an average gas concentration.

Since the control unit controls the detection light source unit on the basis of the distance to the object measured by the distance measurement unit in such a gas detection device, the modulation frequency of the detection light can be controlled according to the distance to the object even if the distance to the object is extended. Thus, the degradation of detection accuracy associated with the extension of the distance to the object can be reduced.

In another aspect, the above gas detection device further includes a timing adjustment unit for adjusting a synchronous detection timing of the phase-sensitive detection unit on the basis of the distance to the object measured by the distance measurement unit in these gas detection devices described above.

In the frequency modulation method (2f detection method), if the modulation frequency is increased, the phase of the synchronization signal is delayed due to a propagation time of the detection light. If a frequency obtained by increasing the modulation frequency is about several kHz or 10 kHz, the degradation of detection accuracy caused by this phase delay is inconspicuous (not problematic). However, if the modulation frequency is further increased for faster detection, the phase delay of the synchronization signal caused by the propagation time becomes larger and the influence of the propagation time is large. For example, when the phase delay is about 1° at a relatively low modulation frequency (e.g. 10 kHz) between equidistant objects, the phase delay is about 10° if the modulation frequency is set ten times as high (100 kHz in the above example). Since the distance to the object is actually measured by the distance measurement unit in the above gas detection device, a propagation time of the detection light and the reflected time can be obtained and the synchronous detection timing based on the propagation time can be obtained. Since the above gas detection device adjusts the synchronous detection timing of the phase-sensitive detection unit using this obtained synchronous detection timing, the degradation of detection accuracy can be reduced even if the modulation frequency is further increased.

In another aspect, in these gas detection devices described above, the distance measurement unit includes an optical distance measurement unit for irradiating distance measurement light having a frequency different from that of the detection light, receiving second reflected light of the distance measurement light by the object and measuring the distance to the object on the basis of an irradiation timing of irradiating the distance measurement light and a light reception timing of receiving the second reflected light, and a first optical axis of the detection light in the detection light source unit and a second optical axis of the distance measurement light in the distance measurement unit are substantially coaxial. Preferably, in the above gas detection devices, the frequency of the detection light is a frequency of an absorption line in the detection target gas and the frequency of the distance measurement light is a frequency other than the frequency of the absorption line in the detection target gas.

Since the first and second optical axes are substantially coaxial with each other in such gas detection devices, the distance to the object that generates reflected light can be reliably measured, wherefore the gas can be more accurately detected.

In another aspect, in these gas detection devices described above, the distance measurement unit includes an optical distance measurement unit for irradiating distance measurement light having a frequency different from that of the detection light, receiving second reflected light of the distance measurement light by the object and measuring the distance to the object on the basis of an irradiation timing of irradiating the distance measurement light and a light reception timing of receiving the second reflected light, and a first optical axis of the detection light in the detection light source unit and a second optical axis of the distance measurement light in the distance measurement unit are parallel. Preferably, in the above gas detection devices, the first and second optical axes are proximately parallel to each other, more preferably most proximately parallel without overlapping each other.

Since the first and second optical axes are parallel to each other in such gas detection devices, the interference of the detection light and the distance measurement light can be prevented, wherefore the gas can be more accurately detected.

In another aspect, in these detection devices described above, the distance measurement unit includes an optical distance measurement unit for irradiating distance measurement light having a frequency different from that of the detection light, receiving second reflected light of the distance measurement light by the object using a distance measurement light reception unit and measuring the distance to the object on the basis of an irradiation timing of irradiating the distance measurement light and a light reception timing of receiving the second reflected light, and a light receiving sensitivity wavelength band of the detection light reception unit and a second light receiving sensitivity wavelength band of the distance measurement light reception unit are different from each other by a predetermined sensitivity threshold value or larger. In terms of suitably receiving light in a 1600 nm wavelength band, the light reception unit preferably includes an InGaAs (indium gallium arsenide) light receiving element in the above gas detection devices. In terms of suitably receiving light in a wavelength band of 800 nm to 1000 nm, the second light reception unit in the optical distance measurement unit preferably includes a Si (silicone) light receiving element, more preferably includes a Si avalanche photodiode in the above gas detection devices.

Since the light receiving sensitivity wavelength band of the light reception unit and the second light receiving sensitivity wavelength band of the second light reception unit are different from each other by the predetermined sensitivity threshold value in such gas detection devices, the reception of the second reflected light by the light reception unit can be reduced and the reception of the reflected light by the second light reception unit can be reduced. Thus, the above gas detection devices can reduce noise caused by the reception of the second reflected light by the light reception unit and reduce noise caused by the reception of the reflected light by the second light reception unit, wherefore the gas can be more accurately detected. Further, because of this, the above gas detection devices have a possibility of being able to omit a filter for reducing the reception of the second reflected light in the light reception unit and a filter for reducing the reception of the reflected light in the second light reception unit depending on accuracy required for the above gas detection devices.

In another aspect, a wavelength of the detection light in the detection light source unit is 1651 nm or 1653 nm in these gas detection devices described above.

The wavelength of 1651 nm or 1653 nm is an R(4) line or R(3) line at which methane is most strongly absorbed, and the above gas detection devices can suitably detect methane as the detection target gas. Further, by setting the wavelength of the detection light at 1651 nm or 1653 nm, an InGaAs light receiving element having light receiving sensitivity to a 1600 nm wavelength band can be suitably utilized as the light reception unit in the above gas detection devices.

In another aspect, a wavelength of the distance measurement light in the optical distance measurement unit is any one of wavelengths in a wavelength range of 800 nm to 1000 nm in these gas detection devices described above.

By setting the wavelength of the distance measurement light at any one of the wavelengths in the wavelength range of 800 nm to 1000 nm, a Si light receiving element having light receiving sensitivity to this wavelength range of 800 nm to 1000 nm can be suitably utilized as the second light reception unit in the optical distance measurement unit in the above gas detection devices.

A gas detection method according to another aspect includes a detection light irradiation step of irradiating detection light frequency-modulated using a predetermined frequency as a center frequency while scanning the detection light along a predetermined scanning direction, a light reception step of receiving reflected light of the detection light by an object, a phase-sensitive detection step of performing a phase-sensitive detection of a light reception output signal obtained in the light reception step, a sampling step of sampling a detection output signal obtained in the phase-sensitive detection step, a gas detection step of detecting detection target gas on the basis of a sampling result obtained in the sampling step, a scanning speed acquisition step of obtaining a scanning speed in the detection light irradiation step, and a control step of controlling the detection light source unit such that the detection light is frequency-modulated at a higher modulation frequency as the scanning speed obtained in the scanning speed acquisition step becomes faster. Preferably, in another aspect, a gas detection method includes a detection light irradiation step of irradiating detection light frequency-modulated at a predetermined modulation frequency using a predetermined frequency as a center frequency while scanning the detection light along a predetermined scanning direction, a light reception step of receiving reflected light of the detection light, a phase-sensitive detection step of performing a phase-sensitive detection of a light reception output signal obtained in the light reception step, a sampling step of sampling a detection output signal obtained in the phase-sensitive detection step at a predetermined sampling period, a gas detection step of detecting detection target gas on the basis of a sampling result obtained in the sampling step, a scanning speed acquisition step of obtaining a scanning speed in the detection light irradiation step, and a control step of controlling each of the detection light source step, the phase-sensitive detection step and the sampling step on the basis of the scanning speed obtained in the scanning speed acquisition step, the phase-sensitive detection step includes a synchronization signal generation step of generating a synchronization signal having a frequency, which is twice the modulation frequency, a detection step of synchronously detecting the light reception output signal obtained in the light reception step using the synchronization signal generated in the synchronization signal generation step and a low-pass filter step of filtering a synchronous detection output signal obtained in the detection step by a low-pass filter unit, and the control step controls each of the detection light irradiation step, the synchronization signal generation step and the low-pass filter step of the phase-sensitive detection step, and the sampling step on the basis of the scanning speed obtained in the scanning speed acquisition step.

Since the control step controls the detection light source unit on the basis of the scanning speed obtained in the scanning speed acquisition step in such gas detection methods, the modulation frequency of the detection light can be controlled according to the increased scanning speed even if the scanning speed increased. Thus, the degradation of detection accuracy associated with the increase of the scanning speed can be reduced.

A gas detection method according to another aspect includes a detection light irradiation step of irradiating detection light frequency-modulated using a predetermined frequency as a center frequency while scanning the detection light along a predetermined scanning direction, a light reception step of receiving reflected light of the detection light by an object, a phase-sensitive detection step of performing a phase-sensitive detection of a light reception output signal obtained in the light reception step, a sampling step of sampling a detection output signal obtained in the phase-sensitive detection step, a gas detection step of detecting detection target gas on the basis of a sampling result obtained in the sampling step, a distance measurement step of measuring a distance to the object, and a control step of controlling the detection light irradiation step such that the detection light is frequency-modulated at a higher modulation frequency as the distance to the object measured in the distance measurement step becomes longer. Preferably, in another aspect, a gas detection method includes a detection light irradiation step of irradiating detection light frequency-modulated at a predetermined modulation frequency using a predetermined frequency as a center frequency while scanning the detection light along a predetermined scanning direction, a light reception step of receiving reflected light of the detection light, a phase-sensitive detection step of performing a phase-sensitive detection of a light reception output signal obtained in the light reception step, a sampling step of sampling a detection output signal obtained in the phase-sensitive detection step at a predetermined sampling period, a gas detection step of detecting detection target gas on the basis of a sampling result obtained in the sampling step, a distance measurement step of measuring a distance to the object, to which the detection light is irradiated and which generates the reflected light based on the detection light, and a control step of controlling each of the detection light source step, the phase-sensitive detection step and the sampling step on the basis of the distance to the object obtained in the distance measurement step, the detection light is radially irradiated while being scanned in the detection light irradiation step, the phase-sensitive detection step includes a synchronization signal generation step of generating a synchronization signal having a frequency, which is twice the modulation frequency, a detection step of synchronously detecting the light reception output signal obtained in the light reception step using the synchronization signal generated in the synchronization signal generation step and a low-pass filter step of filtering a synchronous detection output signal obtained in the detection step by a low-pass filter unit, and the control step controls each of the detection light irradiation step, the synchronization signal generation step and the low-pass filter step of the phase-sensitive detection step, and the sampling step on the basis of the distance to the object obtained in the distance measurement step.

Since the control step controls the detection light source unit on the basis of the distance to the object measured in the distance measurement step in such gas detection methods, the modulation frequency of the detection light can be controlled according to the distance to the object even if the distance to the object is extended. Thus, the degradation of detection accuracy associated with the extension of the distance to the object can be reduced.

This application is based on Japanese Patent Application No. 2015-143045 filed on Jul. 17, 2015, and the contents thereof are included in this application.

To express the present invention, the present invention has been appropriately and sufficiently described through the embodiment with reference to the drawings above. However, it should be recognized that those skilled in the art can easily modify and/or improve the embodiment described above. Therefore, it is construed that modifications or improvements made by those skilled in the art are included within the scope of the appended claims unless those modifications or improvements depart from the scope of the appended claims

### INDUSTRIAL APPLICABILITY

According to the present invention, it is possible to provide a gas detection device and a gas detection method.

1. A gas detection device for detecting gas, comprising:
a detection light source that irradiates detection light frequency-modulated using a predetermined frequency as a center frequency while scanning the detection light along a predetermined scanning direction;
a detection light receiver that receives reflected light of the detection light by an object;
a phase-sensitive detector that performs a phase-sensitive detection of a light reception output signal of the detection light receiver;
a sampler that samples a detection output signal of the phase-sensitive detection unit;
a gas detector that detects gas between the gas detection device and the object on the basis of a sampling result of the sampler;
a scanning speed acquirer that obtains a scanning speed of the detection light source; and
a controller that controls the detection light source unit such that the detection light is frequency-modulated at a higher modulation frequency as the scanning speed obtained by the scanning speed acquirer becomes faster.

2. A gas detection device according to claim 1, wherein:
the phase-sensitive detector includes a detector that synchronously detects the light reception output signal of the detection light receive using a synchronization signal; and
the controller changes the synchronization signal on the basis of the scanning speed obtained by the scanning speed acquirer.

3. A gas detection device according to claim 2, wherein:
the phase-sensitive detector includes a low-pass filter, to which an output signal of the detector is input and by which components having a higher frequency than a cut-off frequency are reduced; and
the controller changes the cut-off frequency on the basis of the scanning speed obtained by the scanning speed acquirer.

4. A gas detection device according to claim 1, wherein:
the controller controls the sampler to sample at a shorter period as the scanning speed obtained by the scanning speed acquirer becomes faster.

5. A gas detection device according to claim 1, further comprising a distance meter that measures a distance to the object, wherein:
the controller controls a sampling frequency of the sampler on the basis of the scanning speed obtained by the scanning speed acquirer and the distance to the object measured by the distance meter.

6. A gas detection device for detecting gas, comprising:
a detection light source that irradiates detection light frequency-modulated using a predetermined frequency as a center frequency while scanning the detection light along a predetermined scanning direction;
a detection light receiver that receives reflected light of the detection light by an object;
a phase-sensitive detector that performs a phase-sensitive detection of a light reception output signal of the detection light receiver;
a sampler that samples a detection output signal of the phase-sensitive detection unit;
a gas detector that detects gas between the gas detection device and the object on the basis of a sampling result of the sampler;
a distance meter that measures a distance to the object; and
a controller that controls the detection light source unit such that the detection light is frequency-modulated at a higher modulation frequency as the distance to the object measured by the distance meter becomes longer.

7. A gas detection device according to claim 5, further comprising a timing adjuster that adjusts a synchronous detection timing of the phase-sensitive detector on the basis of the distance to the object measured by the distance meter.

8. A gas detection device according to claim 5, wherein:
the distance meter includes an optical distance meter that irradiates distance measurement light having a frequency different from that of the detection light, receives second reflected light of the distance measurement light by the object and measures the distance to the object on the basis of an irradiation timing of irradiating the distance measurement light and a light reception timing of receiving the second reflected light; and
a first optical axis of the detection light in the detection light source and a second optical axis of the distance measurement light in the distance meter are substantially coaxial.

9. A gas detection device according to claim 5, wherein:
the distance meter includes an optical distance meter that irradiates distance measurement light having a frequency different from that of the detection light, receives second reflected light of the distance measurement light by the object and measures the distance to the object on the basis of an irradiation timing of irradiating the distance measurement light and a light reception timing of receiving the second reflected light; and
a first optical axis of the detection light in the detection light source and a second optical axis of the distance measurement light in the distance meter are parallel.

10. A gas detection device according to claim 5, wherein:
the distance meter includes an optical distance meter that irradiates distance measurement light having a frequency different from that of the detection light, receives second reflected light of the distance measurement light by the object using a distance measurement light reception unit and measures the distance to the object on the basis of an irradiation timing of irradiating the distance measurement light and a light reception timing of receiving the second reflected light; and
a light receiving sensitivity wavelength band of the detection light receiver and a second light receiving sensitivity wavelength band of the distance measurement light receiver are different from each other by a predetermined sensitivity threshold value or larger.

11. A gas detection device according to claim 1, wherein a wavelength of the detection light in the detection light source is 1651 nm or 1653 nm.

12. A gas detection device according to claim 8, wherein a wavelength of the distance measurement light in the optical distance meter is any one of wavelengths in a wavelength range of 800 nm to 1000 nm.

13. A gas detection method, comprising:
a detection light irradiation step of irradiating detection light frequency-modulated using a predetermined frequency as a center frequency while scanning the detection light along a predetermined scanning direction;
a light reception step of receiving reflected light of the detection light by an object;
a phase-sensitive detection step of performing a phase-sensitive detection of a light reception output signal obtained in the light reception step;
a sampling step of sampling a detection output signal obtained in the phase-sensitive detection step;
a gas detection step of detecting detection target gas on the basis of a sampling result obtained in the sampling step;
a scanning speed acquisition step of obtaining a scanning speed in the detection light irradiation step; and
a control step of controlling the detection light irradiation step such that the detection light is frequency-modulated at a higher modulation frequency as the scanning speed obtained in the scanning speed acquisition step becomes faster.

14. A gas detection method, comprising:
a detection light irradiation step of irradiating detection light frequency-modulated using a predetermined frequency as a center frequency while scanning the detection light along a predetermined scanning direction;
a light reception step of receiving reflected light of the detection light by an object;
a phase-sensitive detection step of performing a phase-sensitive detection of a light reception output signal obtained in the light reception step;
a sampling step of sampling a detection output signal obtained in the phase-sensitive detection step;
a gas detection step of detecting detection target gas on the basis of a sampling result obtained in the sampling step;
a distance measurement step of measuring a distance to the object; and
a control step of controlling the detection light irradiation step such that the detection light is frequency-modulated at a higher modulation frequency as the distance to the object measured in the distance measurement step becomes longer.

15. A gas detection device according to claim 6, wherein a wavelength of the detection light in the detection light source is 1651 nm or 1653 nm.
